(19) United States
(12) Patent Application Publication
(10) Pub. No.: US 2008/0270240 A1
(43) Pub. Date: Oct. 30, 2008

(54) SYSTEMS AND METHODS OF MANAGING TASKS ASSIGNED TO AN INDIVIDUAL

(76) Inventor: Viva Chu, Oakland, CA (US)

Correspondence Address: STRATEGIC PATENTS P.C.., C/O PORTFOLIOIP, P.O. BOX 52050, MINNEAPOLIS, MN, 55402, US

(21) Appl. No.: 12/112,119

(22) Filed: Apr. 30, 2008

Related U.S. Application Data
(60) Provisional application No. 60/915,002, filed on Apr. 30, 2007.
(60) Provisional application No. 60/957,617, filed on Aug. 23, 2007.

(51) Int. Cl. G06Q 30/00; G09B 7/00; G06F 9/00

(52) U.S. Cl. 705/14; 434/350; 705/9

(57) ABSTRACT

In embodiments of the present invention, a method for managing tasks comprises assigning a task to an individual, associating the task with a points value, receiving an indication that a task is completed, grading the completed task, and awarding points for a completed task to an individual. In other embodiments of the present invention, a method of rewarding individuals for completing assigned tasks may comprise providing a collecting, matching, and trading game facility, wherein the facility provides collectables and collectable packs for collecting, matching, and trading as a reward for having reached a level of task completion; and allowing the individual access to the collecting, matching, and trading game facility, wherein access is based on at least one of permission, a task completed, a number of tasks completed, and a value associated with task completion.

### CROSS-REFERENCE TO RELATED APPLICATIONS

This application claims the benefit of the following provisional applications, each of which is hereby incorporated by reference in its entirety:

U.S. Provisional Application 60/915,002, filed Apr. 30, 2007; and U.S. Provisional Application 60/957,617, filed Aug. 23, 2007.

### BACKGROUND

1. Field

The present invention relates generally to task management. More particularly, the present invention relates to systems and methods of managing tasks assigned by a manager to an individual comprising an online task management system where task completion earns individual points which may be exchanged for rewards, privileges, game play, and the like.

2. Description of the Related Art

Teaching kids to do complete a task in a diligent, satisfactory, and timely fashion is often difficult. Kids may not be motivated to complete a task, may be bored by the task, or may find no benefit from having completed the task. While offering monetary rewards to kids for completion of tasks, they may not learn the value of saving up towards a goal if they receive immediate gratification in the form of cash.

A need exists for a simple task management system for managers where the system may be used to set goals and rewards to motivate the individual to complete a task, reward the individual for completing a task, teach the individual concepts related to diligence and saving, and allow the individual to enjoy manager-approved rewards, privileges, and game play associated with points earned upon task completion.

### SUMMARY

Provided herein may be methods and systems for managing tasks assigned to an individual by providing a system of goals and rewards, including a collection, matching, and trading game.

In an aspect of the invention, a method of rewarding individuals for completing assigned tasks may comprise providing a collecting, matching, and trading game facility, wherein the facility provides collectables and collectable packs for collecting, matching, and trading as a reward for having reached a level of task completion; and allowing the individual access to the collecting, matching, and trading game facility, wherein access is based on at least one of permission, a task completed, a number of tasks completed, and a value associated with task completion.

In an embodiment, the method may further comprise providing an additional reward for having reached a threshold level of task completion. In an example of this embodiment, the reward may be at least one of Internet time, television time, a real world item, a virtual item, a downloadable item, charity, allowance, a short term reward, a long term reward, and a privilege. In an example of this embodiment, the method may further comprise providing a policy restricting access to the television during television time. In an example of this embodiment, the policy may be implemented by a V-chip. In an example of this embodiment the reward may be dependent on an individual's grades or grade point average.

In an embodiment, the task may be at least one of a chore, a behavior, a health-related task, a study-related task, reading books, doing homework, studying, practicing an instrument, sport, or extracurricular activity, being well behaved, eating vegetables and fruits, exercising, other healthy living, brushing one's teeth, combing hair, washing, practicing good hygiene, completing an assignment, making a new friend, making a new business contact, giving a speech, and the like. In an example of this embodiment, the book may be read on an e-book facility.

In an embodiment, the task may be a self-assigned task. In an embodiment, the method may further comprise categorizing an assigned task by a category within a To Do chart. In an example of this embodiment, the method may further comprise providing a level meter associated with a To Do Chart for indicating a status of task completion. In an example of this embodiment, the collectable theme may be associated with a level meter status. In an example of this embodiment, a pack of collectables received for reaching a particular level may span multiple collections.

In an embodiment, the collectables may be collected individually. In an embodiment, the collectables may be collected by the pack. In an embodiment, the artwork for the collectable may depict at least one of a real world item, a character, a celebrity, an athlete, a musician, a pop culture icon, people, places, and a board game. In an embodiment, each collectable may have a description about the significance and history of the collectable or collection. In an embodiment, each collectable may contain a narrated or animated fictional or non fictional story about the significance or history of the collectable or collection. In an embodiment, the individual may have a collectable book associated with a level that stores the collection that they own within the collectable game. In an example of this embodiment, the individual may play a matching game to place the collectable within the appropriate spot within the collectable book and unlock the collectable's full image, description, rareness, and ownership statistics.

In an embodiment, individuals may own multiple copies of the same collectable. In an embodiment, individuals may be able to trade collectables with other individuals to fill out their collections. In an example of this embodiment, the method may further comprise a collectable books main menu of a collectable game facility that may allow individuals to browse collectables, collectable packs, and collections. In an embodiment, the method may further comprise a New Collectables Menu of a collectable game facility, wherein selecting the menu may cause a New Packs dialog to appear. In an example of this embodiment, opening the collectable pack may display the thumbnails of each collectable within the pack in the main frame of the New Pack dialog. In an example of this embodiment, an individual may select a collectable and place the new collectable within its collection by dragging it over the correct collection's icon within the collectable book. In this example, correct and incorrect drops may be indicated by at least one of an audible alert, a visual alert, or a combination thereof. In this example, selecting a collectable may display a contextual menu to allow the individual to pick up the collectable or receive a hint about placement of the collectable in a collectable book. In this example, a correct drop may cause a collection contact sheet to appear with the name of each unlocked and locked collectable appearing under each collectable slot on the contact sheet. In this example, placing the collectable in its slot in the collection contact sheet may comprise matching the picture of the collectable with the name of the collectable. In this example, selecting an unlocked collectable may display at least one of a collectable name, a large image, a collectable rareness, a collectable circulation, the number of copies owned by the individual, a collectable description, and a collection icon.

In an embodiment, the method may further comprise providing a quiz facility in association with the collecting, matching, and trading game facility. The quiz facility may display quizzes about at least one of a collectable, a collectable pack, or a collection. A quiz associated with a collection may only be accessible once the collection is complete. Individuals may earn at least one of points, rewards, privileges, collectables, and collectable packs based on a performance in completing the quiz. Managers of the collecting, matching, and trading facility may create quizzes, where quizzes may be created, managed, graded, and the like. In an example of this embodiment, the quizzes may be associated with the completion of a task, the age of the individual, and the like. Quiz content may be any of a plurality of question types, such as multiple choices, single choice, open-ended, and the like. Quiz content may be associated with facts related to the collectables, such as historical events depicted in the collectables, descriptions of the collectables including clothing and costume, trivia, opinion polls, and the like. In this example quizzes may be automatically graded, and the manager may assign bonus awards upon completion of the quiz. The quiz may be initiated by an event, such as a holiday, a task completed, completion of a level, completion of a collection, and the like. Quizzes may be taken in association with a plurality of social aspects, such as the individual working with another individual where the other individual is also online, managing the publishing of the quiz results, seeing how another individual performed, creating a quiz for a second individual, and the like. In this example, the quiz may also be taken in collaboration with another individual, such as through a chat facility, an IM facility, a virtual play room, and the like.

In an aspect of the invention, a method for managing television access, may comprise selecting an individual for whom to create and/or edit a television access list; selecting and approving television programs to include in a television access list; providing a V-chip to restrict television access; and configuring the V-chip to restrict television access by one or more of the television access list, a time, a type of task completed, and a number of tasks completed.

In an aspect of the invention, a method for managing tasks may comprise assigning at least one task to an individual, associating the at least one task with a points value, receiving an indication that the at least one task is completed, grading the completed task, and awarding points for a completed task to an individual. In an embodiment, points may be accumulated. In an embodiment, points may be exchanged for a reward. In an example of this embodiment, the reward may be based upon one or more of a similar age range, a similar position, a similar expertise, and similar rewards chosen for other individuals. In an example of this embodiment, the reward may be selected from a catalog. The catalog may be dynamic or static. In an example of this embodiment, the method may further comprise approving the reward. In an example of this embodiment, the reward may be Internet time. The method may further comprise providing a policy restricting access to the Internet during Internet time. The policy may be implemented by a browser plug-in. In an embodiment, points may be exchanged for game tokens. In an example of this embodiment, game tokens may be used to exchange for items in a virtual world game. In an example of this embodiment, the number of game items exchanged for a game token may be limited. In an example of this embodiment, game tokens are exchanged for items in a catalog, the selection of items available to an individual may be determined by at least one of a game level, a points or game token balance, and the types and number of tasks completed. Trade of game items with another character may be restricted by at least one of a game level, a points or game token balance, and the types and number of tasks completed. In an example of this embodiment, points or game tokens deposited into a virtual world bank earn interest. The ability to deposit points or game tokens may be restricted by at least one of a game level, a points or game token balance, and the types and number of tasks completed. In an embodiment, the task is a household chore. In an embodiment, the task is reading a book. In an example of this embodiment, the book is read on an e-book facility. In an embodiment, the method further comprises an individual self-assigning a task. In an embodiment, the method further comprises categorizing an assigned task by a category within a To Do chart. In an example of this embodiment, the method further comprises providing level meters associated with a To Do Chart category for indicating a status within a game. In an example of this embodiment, the method further comprises providing hidden game items in a To Do Chart. In an embodiment, the method further comprises deducting points for at least one of an incomplete task, late completion of a task, a poorly completed task, and poor behavior. In an embodiment, the method further comprises deducting points for at least one of an incomplete task, late completion of a task, a poorly completed task, and poor behavior. In an embodiment, associating comprises an algorithm for determining recommended point values assigned to tasks based upon the weighted average of points given to individuals by their managers for tasks completed in the past by individuals who have one or more of a similar age range, a similar position, or a similar expertise. In an embodiment, assigning comprises an algorithm for determining recommended tasks based upon the tasks completed in the past by individuals who have one or more of a similar age range, a similar position, or a similar expertise

In an aspect of the invention, a system for task management may comprise an individual user interface, comprising a scoreboard, a to do management facility, a rewards choice facility, an internet facility, a member newsletter, an Options menu, a virtual world game, an e-book facility, and a chat facility; a manager user interface, comprising a My Individuals facility; a To Do Chart facility, a Rewards catalog facility, an Approve Rewards facility, an Internet Management facility, a Subscription Management facility, an Options menu, a Grade Tasks facility, and a Task History facility; a browser plug-in; a game server; and a chat server.

In an aspect of the invention, a method for task management may comprise creating or editing a task chart for an individual, selecting a task to place in the task chart, providing a timeline for completion of the selected task, selecting a points amounts for each task, and optionally, naming the chart and/or selecting an icon to associate with the task chart.

In an aspect of the invention, a method for creating a rewards catalog may comprise selecting an individual for whom to create and/or edit a rewards catalog, choosing a rewards catalog type from the group comprising dynamic and static, choosing rewards to include in the rewards catalog, determining the points value associated with a reward, and optionally selecting an icon for the catalog. In an embodiment, determining the points value may be facilitated by a point to dollar value multiplier.

In an aspect of the invention, a method for creating balance sheets may comprise a way to select the balance sheet for specific users, for specific dates, and the like. Each individual balance sheet may include individual entries for tasks and bonuses, points assigned, points earned, grades given for each entry, the date that tasks where completed, a checklist of tasks completed, and the like. The balance sheet may allow a view of monthly totals, such as monthly point totals, monthly bonus point totals; average grade for tasks; final balances, such as final total points, final total bonus points, final average grade; and the like. In embodiments, balance sheets may provide points in an accountable manner similar to a checkbook, quicken chart, excel spreadsheet, and the like, which may allow managers and users to keep track of accumulated and used points, such as in an account ledger.

In an aspect of the invention, a method for providing savings goals in association with assigned tasks may comprise being able to choose savings goals from a plurality of categories, such as recreation, charity, cash, rewards, playable game items, downloadable media, or the like. Recreation may be an activity, a trip, or the like. Cash may be an allowance, for college savings, and the like. Rewards may be a toy, a DVD, a video game, and the like. Playable game items may be a character, clothing for the character, a collectable that the character uses with a game, real estate within a virtual game, furniture to populate the real estate, and the like. Downloadable media may be music, movies, cartoons, e-books, comic books, music videos, and the like. In addition, savings goals may be associated with a goals screen, where individual savings goals may be depicted, such as by icons listed in a window of the screen. Individual savings goals may include an indication of the extent to which the goal has been completed, such as by percentage complete. Such an indication may be depicted graphically, such as by a graphical slider or bar graph that shows percent complete, and the like. Points accumulated in a savings goal may also be transferred to another savings goal, transferred to a balance sheet, and the like.

In an aspect of the invention, a method for managing Internet access may comprise selecting an individual for whom to create and/or edit an Internet access bookmark list, selecting and approving Internet websites to include in an Internet access bookmark list, optionally, customizing the name of the bookmark, optionally, uploading a picture to use as the bookmark's icon, providing a browser plug-in to restrict Internet access, and configuring the browser plug-in to restrict Internet access by one or more of the Internet access bookmark list, a time, a points balance, a type of task completed, a number of tasks completed, and the like. In an embodiment, Internet access comprises access to at least one of a webpage, an online or downloadable movie, a streaming or downloadable video, an online or downloadable television show, a podcast, online or downloadable music, and the like.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a task management system.

FIG. 2 shows a screenshot of a user interface for easily creating and managing online chore charts for individuals.

FIG. 3 shows a screenshot of a user interface for managers to grade completed tasks and assign points based upon how well the task was completed.

FIG. 4 shows a screenshot of a user interface for individuals to redeem their points for rewards that are approved by their managers. Managers may purchase approved rewards from any online or walk-in store.

FIG. 5 shows a screenshot of a user interface for individuals and managers to earn bonus points from doing popular tasks and reading recommended books.

FIG. 6 shows a screenshot of a user interface for individuals to use Bonus Points to unlock cartoons, videos, and other fun stuff.

FIG. 7 shows a screenshot of an About Milo webpage.

FIG. 8 depicts an example of a task management system.

FIG. 9 depicts a Collectable Books Main Menu.

FIG. 10 depicts a New Collectables Menu.

FIG. 11 depicts a New Packs dialog.

FIG. 12 depicts selecting a collectable and displaying a contextual menu.

FIG. 13 depicts a New Collectable Collection Hint.

FIG. 14 depicts a collection contact sheet with an incorrectly placed collectable.

FIG. 15 depicts a collection contact sheet with a correctly placed collectable.

FIG. 16 depicts selecting the front of a collectable from a collectable sheet.

FIG. 17 depicts selecting the back of a collectable from a collection sheet.

FIG. 18 depicts a screenshot of a scorecard, which may be the first screen an individual sees when logging in.

FIG. 19 depicts a screenshot of a manager user interface.

FIG. 20 depicts a screenshot of the To Do Chart Facility.

FIG. 21 depicts a screenshot of a Task Charts page.

FIG. 22 depicts a screenshot of a goals screen.

FIG. 23 depicts a screenshot of a balance sheet screen.

FIG. 24 depicts a screenshot of a savings goals screen.

FIG. 25 depicts a screenshot of an example of an expanded savings goal icon.

### DETAILED DESCRIPTION

Provided herein may be methods and systems for managing tasks assigned to an individual by providing a system of goals and rewards. Throughout this disclosure the phrase “such as” means “such as and without limitation”. Throughout this disclosure the phrase “for example” means “for example and without limitation”. Throughout this disclosure the phrase “in an example” means “in an example and without limitation”. Generally, any and all examples may be provided for the purpose of illustration and not limitation.

A manager may be a parent, grandparent, guardian, teacher, employer, or the like. The methods and systems described herein may facilitate a manager setting up an allowance program for individuals and to motivate them to achieve manageable goals. An individual may be a kid, child, dependent, ward, minor, student, sibling, employee, or the like. The methods and systems described herein may facilitate an individual earning points for doing chores, reading books, doing homework, studying, practicing an instrument, sport, or extracurricular activity, being well behaved, eating vegetables and fruits, exercising, other healthy living, brushing one's teeth, combing hair, washing, practicing good hygiene, completing an assignment, making a new friend, making a new business contact, giving a speech, and the like. The points may be used to obtain privileges, such as a sleepover, a chore waiver, a vacation day, and the like; and items, such as Internet time, television time, real world items, downloadable items, virtual items, and the like. Individuals may earn points associated with successful completion of an assigned task. Individuals may have points deducted from a points balance for not completing tasks on time, to a manager's satisfaction, and the like. Individuals may also have points deducted for a points balance for poor behavior.

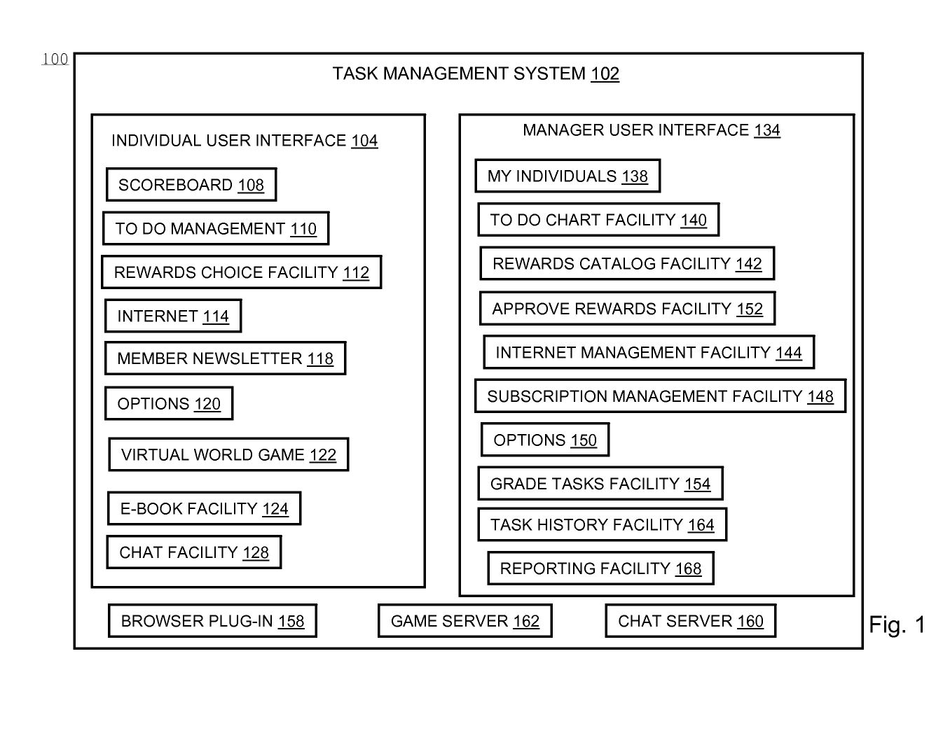

Referring to FIG. 1, a task management system 102 may comprise an individual user interface 104, a manager user interface 134, a browser plug-in 158, a chat server 160, a game server 162, and the like. A manager user interface 134 may comprise My Individuals 138, a To Do Chart Facility 140, a Rewards Catalog facility 142, an Internet Management Facility 144, a Subscription Management Facility 148, Options 150, an Approve Rewards Facility 152, a Reporting Facility 168, and the like. The task management system 102 may be deployed as an internet-based application, a desktop-based application, a wireless application, a combination thereof, or the like. A user interface 134 may be provided for management of tasks and rewards. The user interface 134 may be part of an internet-based application, a desktop-based application, a wireless application, a combination thereof, or the like.

A user interface 134 for managers may comprise a My Individuals facility 138. The My Individuals facility 138 may allow a manager to create and edit a list of individuals they are managing. My Individuals 138 may display icons for each individual linking to the individual's homepage. The My Individuals 138 facility may allow managers to re-assign individuals to another manager, assign a manager to an individual, collaborate with another manager to create and/or manage To Do's, such as a collaboration between a parent and a teacher, and the like.

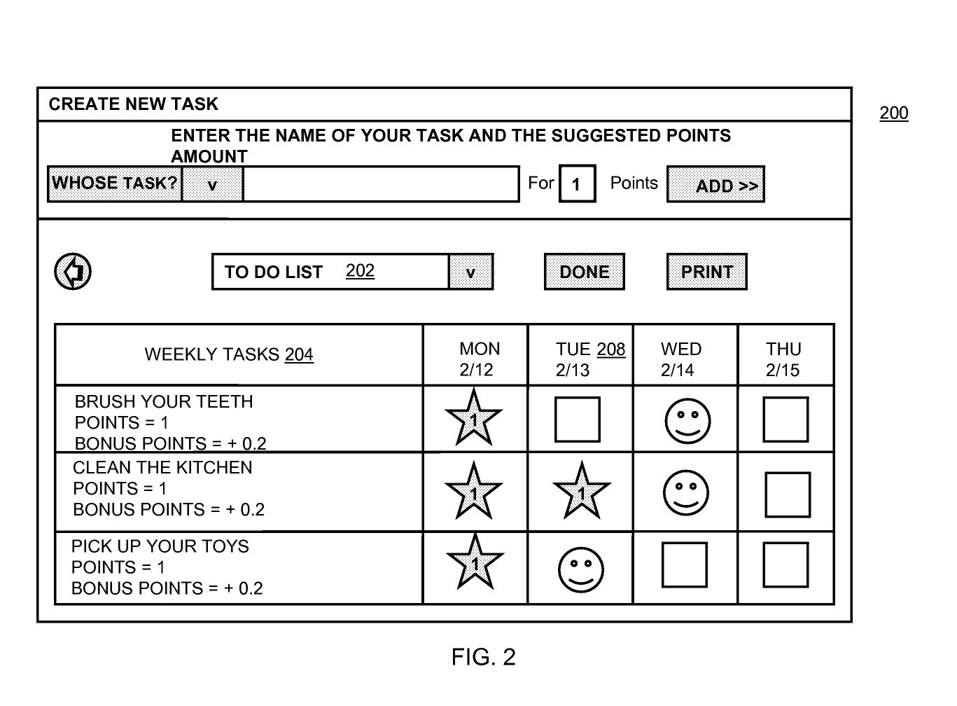

A user interface 134 for managers may comprise a To Do Chart Facility 140. The To Do Chart Facility 140 may be used by a manager to create to do lists and printable chore charts for an individual, help individuals to create weekly To Do and Reading list 504, set goals to motivate an individual to complete tasks, manage goal attainment, grade completed tasks according to how well they were done, assign points values to a task, assign bonus points values to a task, assign rewards commensurate with task completion or goal attainment, assign points deductions for not completing tasks in a timely fashion, satisfactory fashion, or at all, assign points deductions for poor behavior, approve rewards, teach individuals the value of saving, use Bonus Points to get discounts when buying rewards online, and the like. A To Do Chart Facility 140 may comprise a To Do Wizard to create or edit a Task Chart. In an embodiment, a wizard interface may walk managers through the steps for creating or editing a Task Chart for an individual. A first step in the wizard interface may be to select an option such as Create a new chart for <Select Individual>, Edit an existing chart: <Select Chart>, and the like. A second step in the wizard interface may be to ‘Choose a Task’. Managers may select from categories of popular tasks or enter their own tasks. Managers may remove tasks or copy tasks from previously created charts. An algorithm may be used to recommend a task assignment. The recommendation may be based upon an age range, similar tasks completed by other individuals, and the like. A third step in the wizard interface may be to select when each task is to be completed, such as Everyday, Every weekday, Every weekend, One time, due on <optional date>, Pick specific days of the week, and the like. A fourth step in the wizard interface may be to select point amounts for each task. An algorithm may be used to recommend a point value to assign to tasks. The recommendation may be based upon the weighted average of points given to individuals by their managers for tasks completed in the past by individuals who may be of a similar age range, hold a similar position, have similar expertise, and the like. A fifth step in the wizard interface may be to name the chart and, optionally, choose or upload an icon for the chart. Goals and Tasks may show their own image icon. Tasks may be categorized into different categories. For example, a manager may use a drop down menu in a To Do List 202 to organize tasks into categories, such as a separate behavior chart for demerits and good behavior. Referring to FIG. 2, the online task management system 102 may comprise selection of an individual to complete a task and assignment of a number of points awarded for the task. For example, Weekly Tasks 204 may be listed, such as Brush your teeth, Clean the Kitchen, Pick up your Toys, and the like, with a points value associated with completion of each task. A calendar 208 may be displayed where completion of the task for a specified time period may be represented by an icon, a number, a letter, or the like.

The user interface 134 for managers may comprise the Rewards Catalog facility 142. A Rewards Catalog may comprise a set of virtual items, real world items, downloadable items, privileges, money, and the like. In an embodiment, points may be used to exchange for virtual items, privileges, and the like. For example, points may be exchanged for the privilege of a sleepover, a chore waiver, a vacation day, and the like; and items, such as Internet time, television time, real world items, downloadable items, virtual items, a character upgrade in a virtual world game 122, and the like. In an embodiment, the Rewards Catalog facility 142 may integrate with a television V-Chip in order to control the television time reward. In an embodiment, points may be used as currency to buy downloadable and real world items such as music, movies, video games, bikes, dolls, toys, and the like. In an embodiment, the Rewards Catalog facility 142 may facilitate creating a Rewards Catalog for an individual, including rewards such as allowance, charity, downloadable media, playable game items, short term rewards, long term awards, and the like. In embodiments there may be a change allowance button that may display a screen within the current dialog box with a number of button options, such as the individual does not receive allowance, the individual can earn x dollars per week for y points. There may also be a redeem function associated with allowance, where the redeem function may redeem and approve the allowance at the same time. There may be a charity function that displays various options such as the individual is not donating to a charity, the individual gives x dollars to y charity for z points. Long term rewards may be associated with rewards for which individuals save for an item, such as a bike, an Ipod, a camping trip, and the like. Short term rewards may be associated with rewards for which individuals may receive on a daily or weekly basis, such as going to bed one hour past bedtime, going to a friend's house, going to see a movie, and the like. In embodiments, managers may setup multiple short term rewards for each individual.

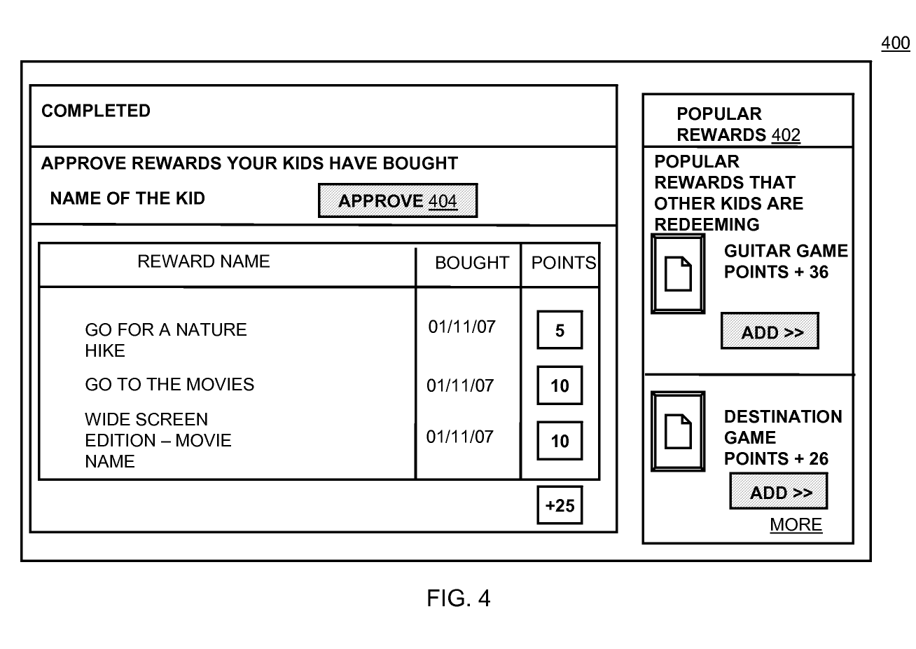

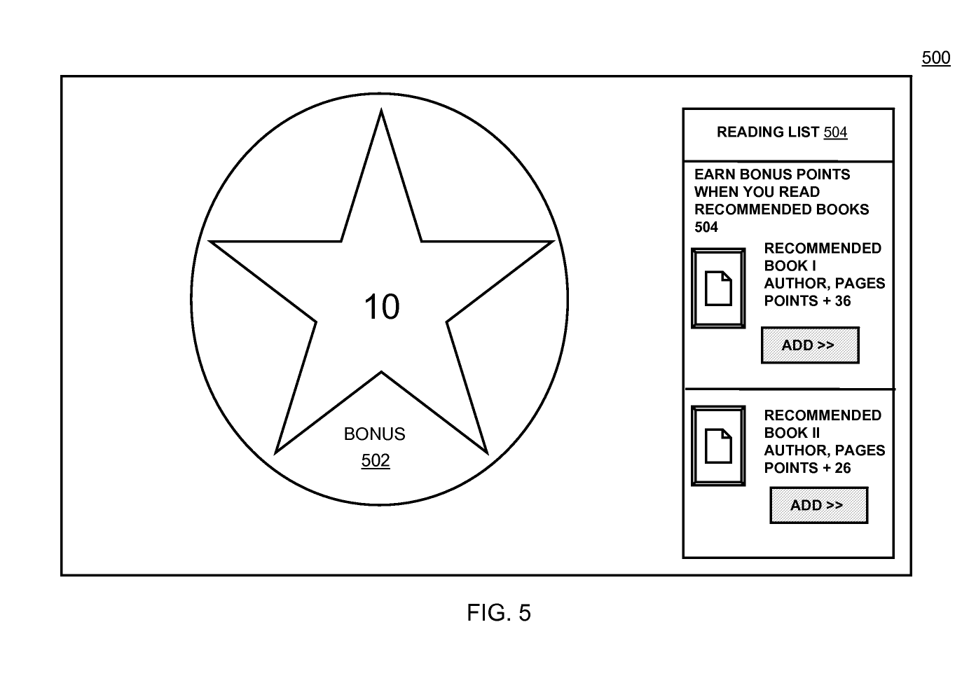

A first step in the wizard interface may be to select an individual for whom to create/edit a reward catalog. A second step in the wizard interface may be to choose a reward catalog type such as a dynamic catalog wherein rewards and reward prices may be recommended to individuals automatically, a static catalog wherein managers choose the specific rewards to display in the catalog, and the like. The dynamic catalog may comprise an auto suggest feature that may suggest a reward as the manager begins to type a possible reward into a text box. A third step in the wizard interface may be to choose Rewards. If a dynamic catalog may be selected, then dynamic reward categories may be selected. Managers may preview the types of rewards that may be included in each category. If a static catalog may be selected, managers may select rewards from popular categories or enter their own rewards. Managers may also remove rewards or copy rewards from previously created reward catalogs. An algorithm may be used to recommend a reward. The recommendation may be based upon an age range, rewards chosen in the past for similar individual, and the like. A fourth step in the wizard interface may be to determine the cost of rewards. For example, reward prices in terms of points may be calculated automatically by multiplying the dollar price of the reward by a Points Exchange Rate. In another example, a specific points amount for each reward may be indicated. This option may not be available if a dynamic rewards catalog may be selected. In any event, for purchase of real world and downloadable items, the points required for purchase of the item may be debited from an individual's points balance. The corresponding dollar amount of the item may be charged to a manager account when a real world or downloadable item may be selected from a rewards catalog. In an embodiment, the point values for a dynamic rewards catalog may be determined by an indicated point-to-dollar value multiplier. For example if a manager indicates that $1 equals 10 points, then a $5 allowance may cost 50 points. A fifth step in the wizard interface may be to select or upload an icon for the catalog. The Rewards Catalog facility 142 may be associated with the Approve Rewards facility 152 to approve rewards that an individual may have purchased. The Approve Rewards facility 152 may maintain a Reward History to view rewards that have been approved, rejected, or are pending approval. Bought or approved rewards may be deleted. The Approve Rewards facility 152 may allow a manager to implement restriction policies. Referring to FIG. 4, the Approve Rewards facility 152 may allow a manager to approve 404, a reward chosen by an individual, view the date the reward was chosen, change the number of points required to obtain the reward, view popular rewards 402, and the like. It may be possible to see what other individuals are saving up for by selecting the Most Popular Rewards 402 drop down in the Goals list. Referring to FIG. 5, bonus points 502 may be awarded for reading a recommended book or the like.

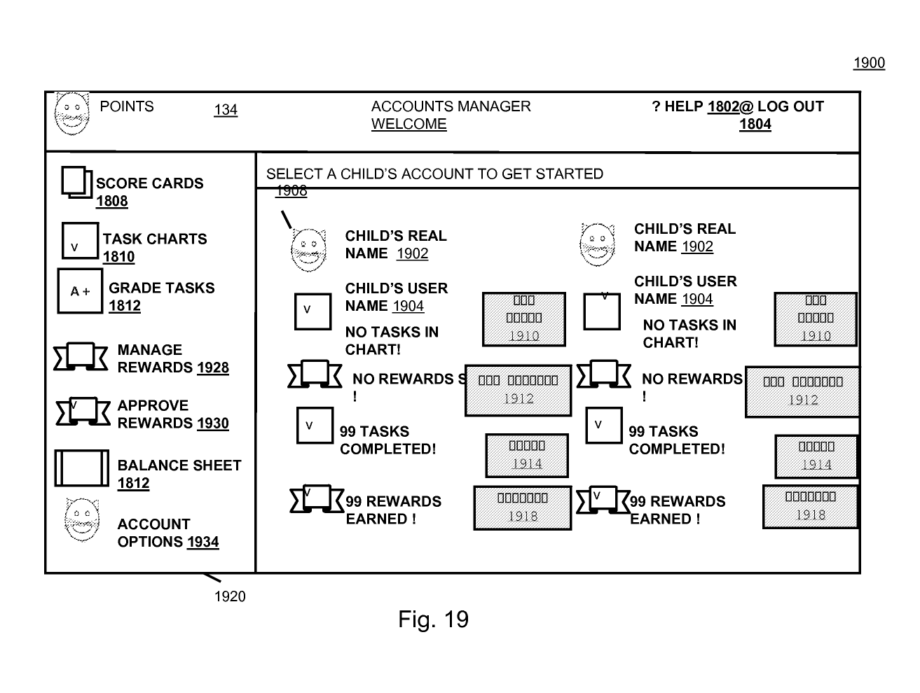

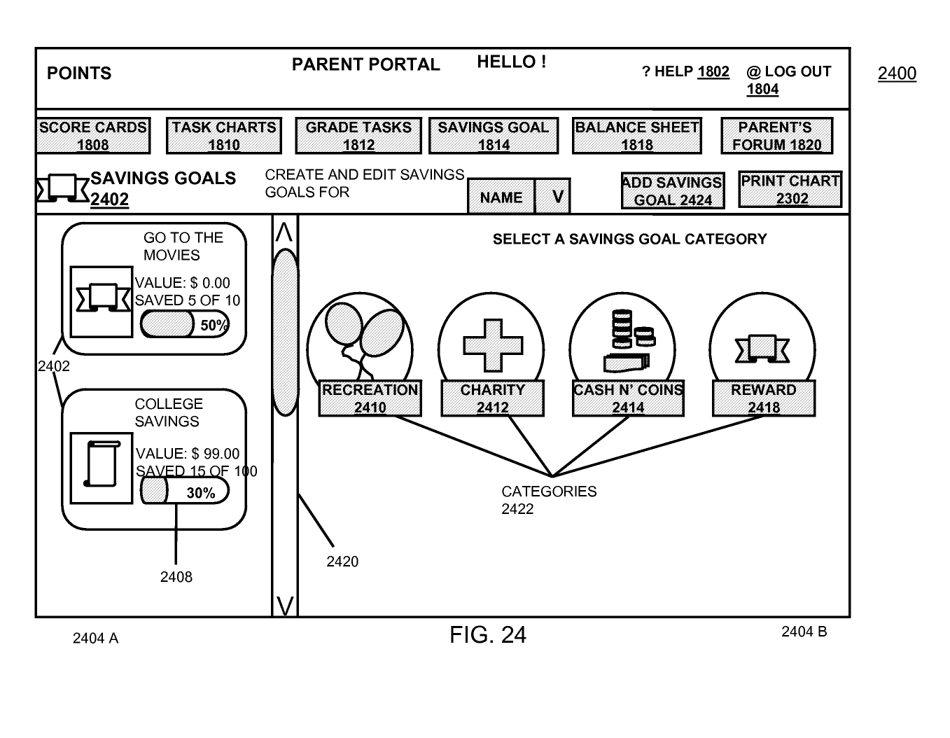

Referring to FIG. 19, an embodiment of the manager user interface 134 is depicted. The My Individuals 138 facility may depict two windows for the two individuals managed. In an alternative embodiment, there may be a drop-down menu with each individual's name listed. Clicking an individual's name may launch a window for that individual. Generally, each window may correlate with an individual. Each window may display an individual's real name 1902, an individual's user name 1904, an icon associated with an individual 1908, an Add Tasks button 1910 to launch a To Do Chart facility 140, an Add Rewards 1912 button to launch a Rewards Catalog facility 142, a Grade button 1914 to launch a Grade Tasks facility 154, an Approve button 1918 to launch an Approve Rewards facility 152, an Add Goals button 2424 as shown in FIG. 24, and the like. The user interface 134 may comprise the Add Goals button 2424. If an individual does not have an allowance, charity goal, or long term or short term reward then this link will appear. If multiple goals are empty, then the Add Goals button 2424 will show only one call to action in order, such as the following order: Allowance, Long Term, Short Term, Charity, and the like. A sidebar 1920 of the user interface 134 may comprise a Scorecards button 1808 to launch a Scoreboard 108, a Task Charts button 1810 to display Task Charts, a Grade button 1812 to display Grades, a Manage Rewards button 1928 and Approve Rewards button 1930 to review pending, granted and rejected rewards, a Balance Sheet button 1812, and an Account Options button 1934 to launch an Options facility 150. The user interface 134 may comprise a Help! Button 1802 and a Log Out button 1804. The user interface 134 may comprise links to Edit 1808 and Delete 1810 an individual's profile. Clicking on the Delete link 1810 may prompt the manager to ask if he/she is sure that he wishes to remove the account; on confirmation the account may be archived. Clicking on the Edit link 1808 may invoke the Options facility 150 to edit a profile for the selected individual. The user interface 134 may comprise a link to Add 1812 an Individual. Selecting this link 1812 may invoke the Options facility 150 to add a new account.

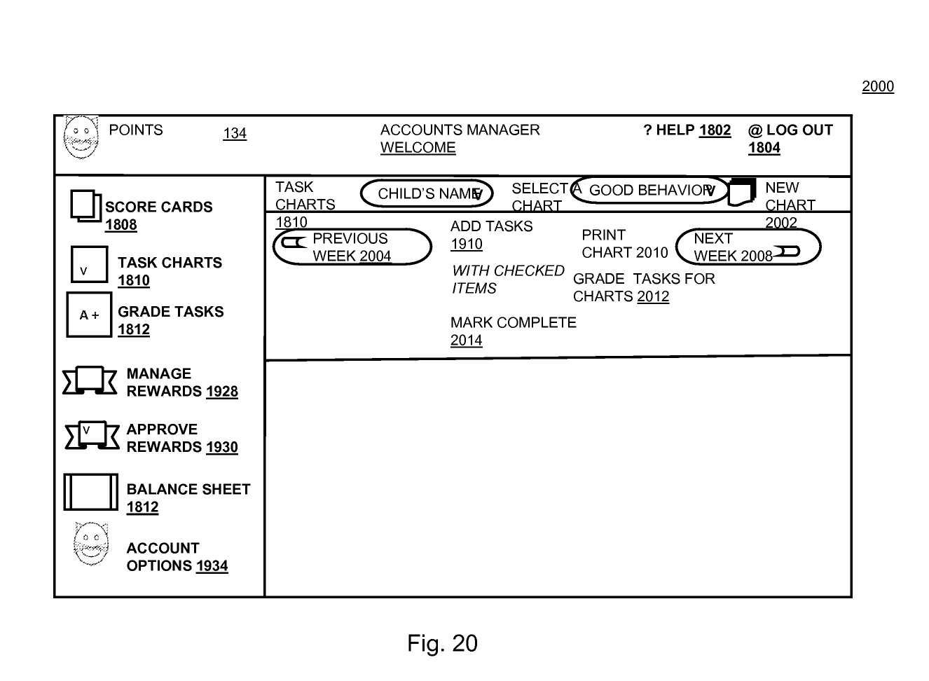

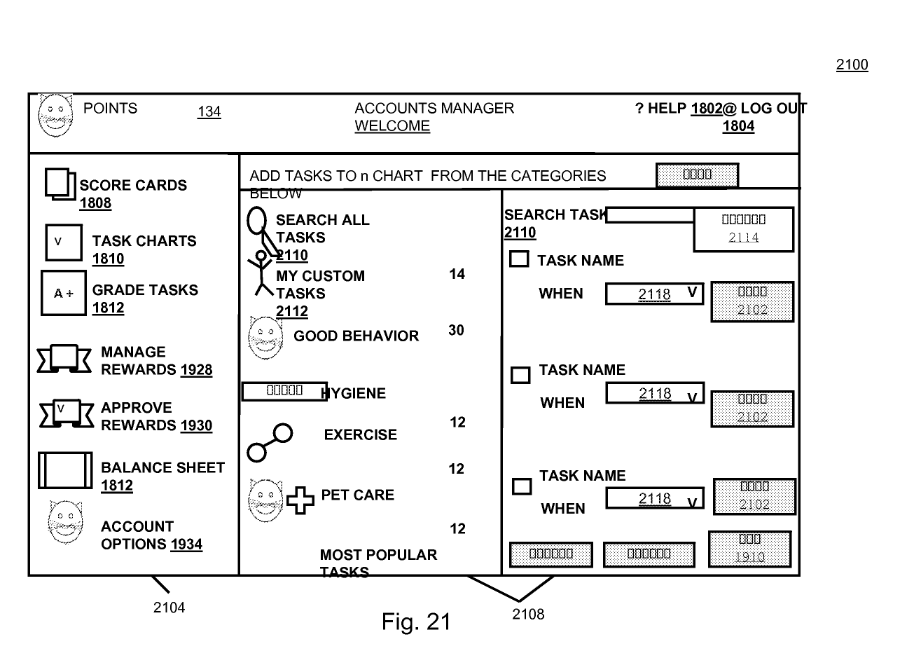

Referring now to FIG. 20, clicking an Add Tasks button 1910 of a manager user interface 134 may bring a manager to an Add Tasks page for a specific chart. If multiple charts are empty, only the first chart sorted alphabetically may appear in this space. Task charts 1810 may be organized by Individual and by Chart. The Individual selection dropdown may displays individuals sorted by alphabetical order by first name and the chart drop down may display an individual's chart sorted alphabetically. When selecting an individual, the individual's default chart may be displayed and the chart selection list may be populated with all of the individual's charts sorted alphabetically by name. The default chart of the first individual is displayed when selecting the left Task Charts navigation menu. The New Chart button 2002 may create a new chart. The Edit Chart button 2102 may bring a manager to the edit chart screen and the delete chart button may display a confirmation page. If an individual only has one chart, the existing chart may not be deleted. The Previous 2004 and Next 2008 buttons may navigate to different weeks. The print button 2010 may display a printable version of the chart currently in view for the selected week. The Grade button 2012 may function on checked tasks within the chart. The Grade button 2012 may mark the tasks as completed and change the main navigation to the Grade tab 2012, automatically selecting the individual for which a manager may wish to grade tasks. In embodiments, the manager may either mark a task complete using the Mark Complete button 2014 or assign a grade to each completed task. The grade action and screen may be refactored in order to accept a letter grade for each graded task. Selecting the Add Tasks button 1910 from the Task Chart 1810 view may display the Add Tasks page, as in FIG. 21.

Referring to FIG. 21, From the Add Tasks page, managers may choose to create a custom task or browse a list of recommended task categories and select multiple tasks. The category browser may comprise left 2104 and middle panes 2108. In the middle frame 2104, managers may pick a category from a list of available categories. For example, the first four categories may be special categories, such as Search Tasks 2110, My Custom Tasks 2112, Most Popular Tasks, and Recommended Books 504. Selecting the Search category may display the search bar 2114 in the left pane. Selecting My Custom Tasks 2112 may display all of the tasks that the manager and individual may have created and “Most Popular Tasks” may display the top 50 most tasks rewards sorted by popularity. Selecting Recommended Books 504 may display a list of recommended books for the selected individual. Selecting a category may display the list of tasks in the right frame 2108. Checking a task may indicate that the manager may wish to add the task 1910 to the chart. Managers may also edit the points value and the schedule for the task. In order to save the changes, managers may select the Save button. Selecting a different category before pressing the save button may prompt to save the current selections before going to a different category. When adding a task, a manager may assign a time schedule for the task by using the scheduling drop down menu 2118. The drop down 2118 may contains the following items: Everyday, Weekdays, Weekends, One time, no due date, One time, due on . . . , On these days . . . , and the like. When selecting “One time, no due date”, a text field may appear under the drop down 2118 to enter the date. When selecting the “On these days . . . ” option, seven check boxes labeled by day abbreviation may appear under the drop down 2118. When selecting the Create Custom Task button 2112 from the main navigation bar of the Add Tasks screen, the category browser may drill into the My Custom Tasks folder and creates a new row at the top of the right pane with text fields for entering the name and points amount for the new task. Pressing the save button may save the task and adds it to the task chart 1810. When a manager selects the Search Tasks category, the right pane may display a search bar above the results list. For example, when conducting a task search 2110, the database may first be searched for any tasks belonging to non-Amazon linked categories that may have been created by the task management system 102, manager or individual matching the search query. Then the Amazon catalog may be dynamically searched using the Amazon API for any Amazon book results. The tasks may be sorted in the following order: (1) manager/individual created tasks sorted alphabetically, (2) Non-Amazon tasks sorted by popularity (how many people have chosen these rewards), and (3) Amazon books sorted by sales rank. When a manager/individual adds an Amazon book to a tasks list, the task may be automatically imported into the task table. If a task already exists, then the data may be updated in the catalog. Book categories may comprise Children's Books, Teens, Comics and Graphic Novels, and the like.

Referring again to FIG. 19, the Grade menu 1812 may display the Grade Tasks facility 154 for grading tasks. The grade tasks facility 154 may have an individual selection drop down that lists all individuals sorted by first name and a View All option. By default the View All option may be selected. When invoked from the chore chart, the selected kid may be passed in as a query argument. The Grade form and submit actions may be refactored to support letter grade assignment for each completed task. A letter grade column may be added to the points table and data models. When managers enter a letter grade, the letter grade may be used to suggest the number of points to allocate. Assigning a letter grade may be done with a clickable letter grade map. The points amount may be displayed as a editable text field whose values change using javascript whenever a new grade may be selected. The Bonus Points amount may be displayed as non editable text values that change using javascript whenever a new graded may be selected. For example, the following letter grade formulas may be used to calculate the suggested points and Bonus Points amounts: A+: 1*points; A: 0.95*points; A−: 0.90*points; B+: 0.88*points; B: 0.85*points; B−: 0.80*points; C+: 0.78*points; C: 0.75*points; C−: 0.70*points; D+: 0.68*points; D: 0.65*points; D−: 0.60*points; F: 0, and the like.

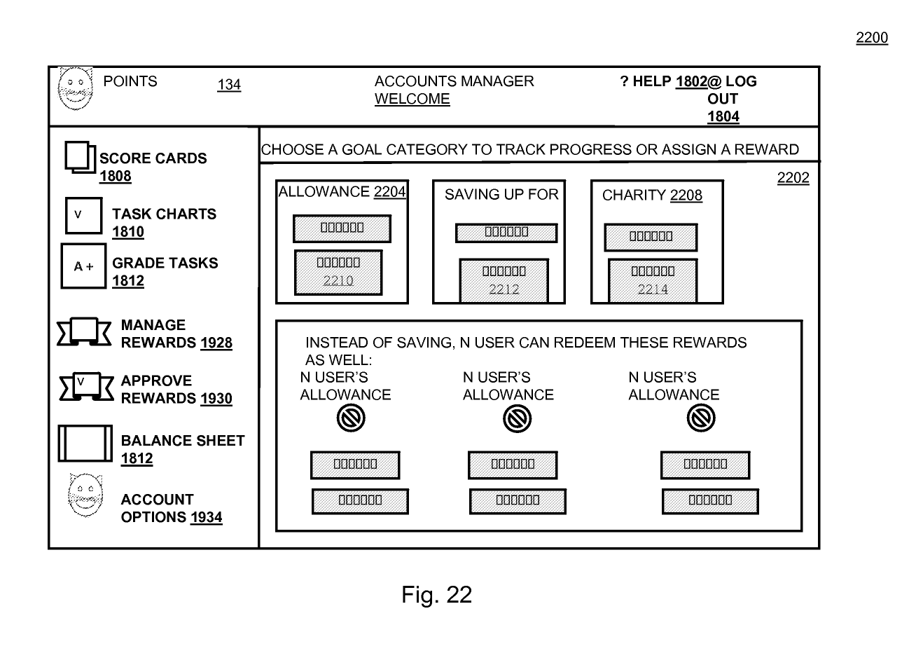

Referring to FIG. 22, a Goals screen 2202 may allow a manager to specify an allowance amount 2204, a charity donation 2208, a reward, a privilege, a long term reward, a list of short term rewards, and the like for each individual, as described herein for the Rewards Catalog facility 142. Selecting an Edit Long Term Reward button may display a screen to select from a list of rewards. The reward category browser may have panes. The left pane may display an alphabetical list of reward categories, and the right pane may display the list of rewards within the selected category. Managers may select a single reward from the list to replace the currently selected Long Term Reward. At the top of the category list may be three special categories: Search Rewards, My Custom Rewards, and Most Popular Rewards 402. “My Custom Rewards” may display all of the rewards that a manager may have created and “Most Popular Rewards 402” may display the top 50 most popular rewards 402 sorted by popularity. The Create New Reward button may automatically select the My Custom Rewards category, display the list of previously created custom rewards in the right pane, and create a new row at the top of the right pane with form fields to enter the reward information. When a manager searches for a new reward, a search bar may appear above the search results in the right pane of the category browser. When conducting a reward search, the database may first be searched for any rewards belonging to non-Amazon linked categories that may have been created by the task management system 102 or created by managers or individuals matching the search query. Then the Amazon catalog may be dynamically searched using the Amazon API for any Amazon reward results. The rewards may be sorted in the following order: (1) manager/individual created rewards sorted alphabetically, (2) Non Amazon rewards sorted by popularity (how many people have chosen these rewards), and (3) Amazon rewards sorted by sales rank. When a manager may add an Amazon reward to a goals list, the reward may be automatically imported into the points reward table. If a reward already exists, then the data may be updated in the catalog. Amazon reward categories may be Gadgets, Movies, Music, Toys, Video Games, and the like. Short term rewards may be rewards individuals receive on a daily or weekly basis. Short term rewards may be repeated rewards that managers use on a regular basis to help motivate individuals. For example, short-term rewards may be “Go to bed one hour past bedtime,” “Go to a friend's house,” or “Go see a movie.” Managers may setup multiple short term rewards for each individual. The selection interface for adding a short term reward may be the same as the one for changing a long term reward but with checkboxes instead of radio buttons for the selection pane. Selecting the print button may bring up a popup window displaying a printable version of the Goals screen 2202 with all of the rewards listed as reward certificates. The Approve menu may display an Approve rewards facility 152 with an individual selection drop down that lists all individuals sorted by first name and a View All option. By default the View All option may be selected. When the Allowance redemption 2210 is approved, the goal may not be removed from the Allowance goal slot 2204. When the Charity redemption 2214 is approved, the goal may not be removed from the Charity goal slot 2208. When the Long Term Reward redemption is approved, the goal may be removed from the Long Term Reward slot. Managers may populate the Long Term Reward slot with a new reward. When Short Term Reward redemption is approved, the goal may not be removed from the Short Term Reward list. After rewards are approved, the RewardAdController may be invoked to display ads and an option to print out certificates for the approved rewards.

Continuing to refer to FIG. 19, the Balance Sheet 1812 view displays positive and negative points transactions in a single view that resembles a check book. Managers may select an individual and a Month. By default the first individual and current month may be displayed. Graded tasks, goal reward deposits, and virtual good item purchases may be displayed as a combined list and may be sorted by completion or purchase or deposit date. Purchase and deposit transactions may be displayed as negative values, and Graded transactions may be displayed as positive values. The summary row may display the sum for the selected time period. A Manager Points may pop-up recent Manager Points articles or point the manager to an RSS feed of recent articles.

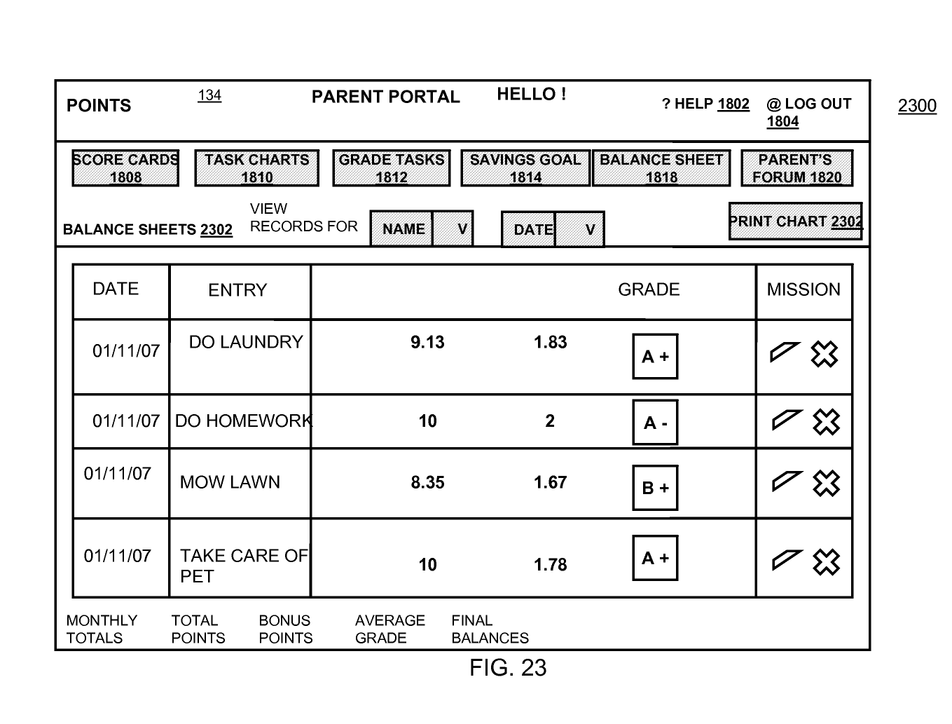

In embodiments, the manager user interface 134 may include balance sheets 2302, such as the example shown in FIG. 23. The balance sheets 2302 may include a way to select a balance sheet for specific users, for specific dates, and the like. Each individual balance sheet may include individual entries for tasks and bonuses, points assigned, points earned, grades given for each entry, the date that tasks were completed, a checklist of tasks completed, and the like. The balance sheets 2302 may allow a view of monthly totals, such as monthly point totals, monthly bonus point totals; average grade for tasks; final balances, such as final total points, final total bonus points, final average grade; and the like. In embodiments, balance sheets 2302 may provide points in an accountable manner similar to a checkbook, Quicken chart, Excel spreadsheet, and the like, which may allow managers and users to keep track of accumulated and used points, such as in an account ledger.

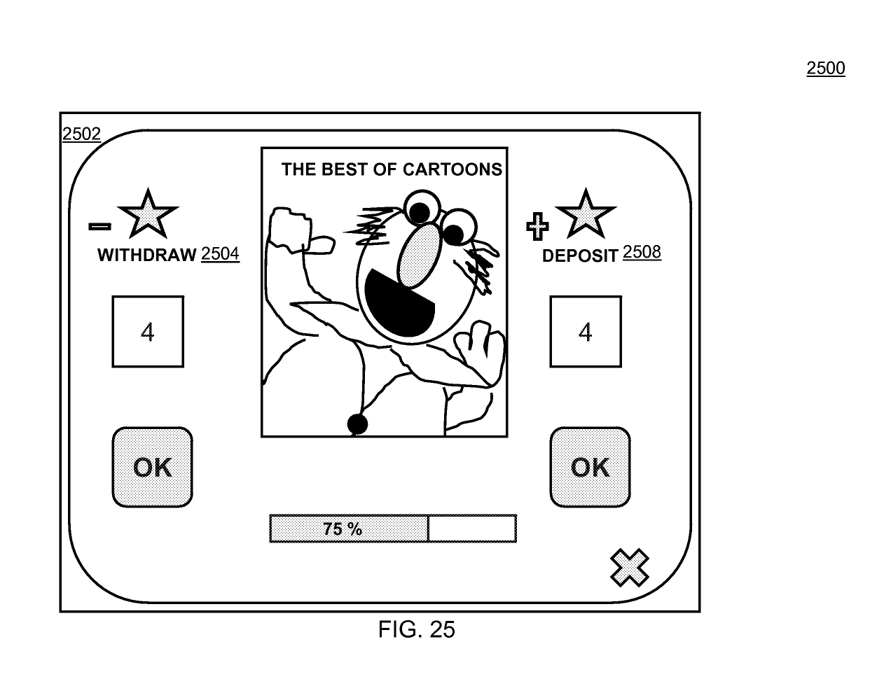

In embodiments, the manager user interface 134 may include savings goals 2402, such as the example shown in FIG. 24. The savings goals sheet 2400 may include a way for managers to set points goals in different categories, such as for recreation 2410, charity 2412, cash 2414, rewards 2418, downloadable media, playable game items, and the like. For example, playable game items may be a character, clothing for the character, a collectable that a character uses with a game, real estate within a virtual game, furniture to populate the real estate, and the like. Downloadable media may be music, movies, cartoons, e-books, comic books, music videos, and the like. The recreation category 2410 may include fun family activities, trips, and the like, to do with the individual. The charity category 2412 may contribute to teaching the individual the virtues of being generous. The cash category 2414 may include a cash savings goal and allowance program for the individual, savings for college, quarters for the arcade, and the like. The reward category 2418 may include setting goals for getting toys, DVDs, video games, and the like. Savings goals 2402 may motivate the individual to do chores and be more responsible. In embodiments, the savings goals sheet 2400 may provide separate windows 2404 A and 2404 B for selecting a savings goals 2402 from a plurality of categories 2422, and for viewing the savings goals 2402 that have been previously selected, such as two windows 2404 A and 2404 B as shown in FIG. 24. As shown, the individual savings goals 2402 may have an indication 2408 as to the individual's progress toward their goal, such as a percentage that may be indicated numerically, graphically, or the like. The selected savings goals window 2404A may also have a slider 2420 so to view all the selected savings goals 2402 for the individual. In addition, the individual savings goals 2402 may be clicked on to show greater detail 2502 or more features available for that selected savings goal 2402, such as shown in FIG. 25 where the greater detail 2502 may include points to withdraw 2504 and points to deposit 2508. For example, negative withdraws 2504 may be made to transfer points from one savings goal to another or to save the points in an individual's general balance sheet. Positive deposits 2508 may be made to get closer to achieving a savings goal.

An Internet Management facility 144 may allow managers to set up a customized Individual's Homepage. An Internet Management facility 144 may comprise a Bookmark Wizard to create or edit a bookmark list. In an embodiment, an Internet Wizard may allow managers to construct bookmarks of popular manager-approved Internet sites to display on an individual's home page. Managers may use this tool to allow an individual to purchase Internet time on their favorite website using their points. A first step in the wizard interface may be to select an individual for whom to create/edit a bookmark list. A second step in the wizard interface may be to pick from a list of popular Internet sites organized by category or add their own site. A third step in the wizard interface may be to customize the name of the bookmark and upload a picture to use as the bookmark's icon. A fourth step in the wizard interface may be a request to download a browser plug-in 158 and set the user interface webpage as their home page. The plug-in 158 may allow a manager to limit an individual's time on the Internet, access to the Internet, or access to a specific Internet site by a points balance, the type and/or number of completed tasks, and the like. The plug-in 158 may allow a manager to restrict an individual's access to certain selected Internet sites, selected Internet site categories, Internet sites with a certain rating, Internet sites with restricted words or character strings, and the like. The plug-in 158 may allow a manager to restrict an individual's Internet access to outbound links and downloads. The plug-in 158 may allow a manager to restrict an individual's ability to trade Game Items by a number, a game item type, a game item value, any trade, and the like. A fifth step in the wizard interface may be to configure browser plug-in options if such plug-in may be detected. One configurable option may be to only allow an individual to visit the selected sites. Another configurable option may be to not restrict the amount of time that an individual may spend online or restrict an individual to a time, such as N hours per day, N hours per week, or the like. An individual may be able to purchase additional Internet time using points. For example, 1 hour of additional Internet time may equal N points.

A browser plug-in 158 may allow individuals to purchase Internet time from their managers using points. The browser plug-in 158 may monitor the amount of time that a user may spend online and restricts what sites an individual may visit based upon their managers' preferences as described above. If the plug-in 158 is installed, once a new browser window is started, the user may be automatically directed to login to the user interface webpage. If the user logging in is the manager, then the browser may be directed to the home page that is configured with the browser. If the user is an individual, then the browser may be directed to the individual's home page and a timer may be started. If an individual attempts to enter a site that is restricted by the manager, a message may be displayed informing the individual that his/her manager must approve the site before he/she may access it. The individual then may have the option to submit the site for approval. Submission may be automatic or optional. The browser plug-in 158 may display as a toolbar within the browser menu with options such as Score: points and game token balances; Timer: Amount of time spent online during period and amount of time remaining within the period (The period may be either hours, days, weeks, or the like as configured by the manager.); To Do Charts: list of chore charts; Go Shopping: link to reward catalog; Bookmarks: drop down list of approved Internet sites; Game: link to a virtual world game; Logout: link to logout and stop the timer; Change User, and the like. If a browser may be left inactive, then the timer may be stopped and the user may be logged out automatically. There may be a threshold time for inactivation, such as inactivity for more than 15 minutes. If an individual exceeds the amount of time allowed, then a message may be displayed to the individual. If the manager has allowed the individual to purchase more time using accumulated points, the individual may be asked whether he/she would like to purchase more time.

A user interface 134 for managers may comprise a Subscription Management facility 148. The Subscription facility 148 may allow a manager to manage a subscription, pay for a subscription, and the like.

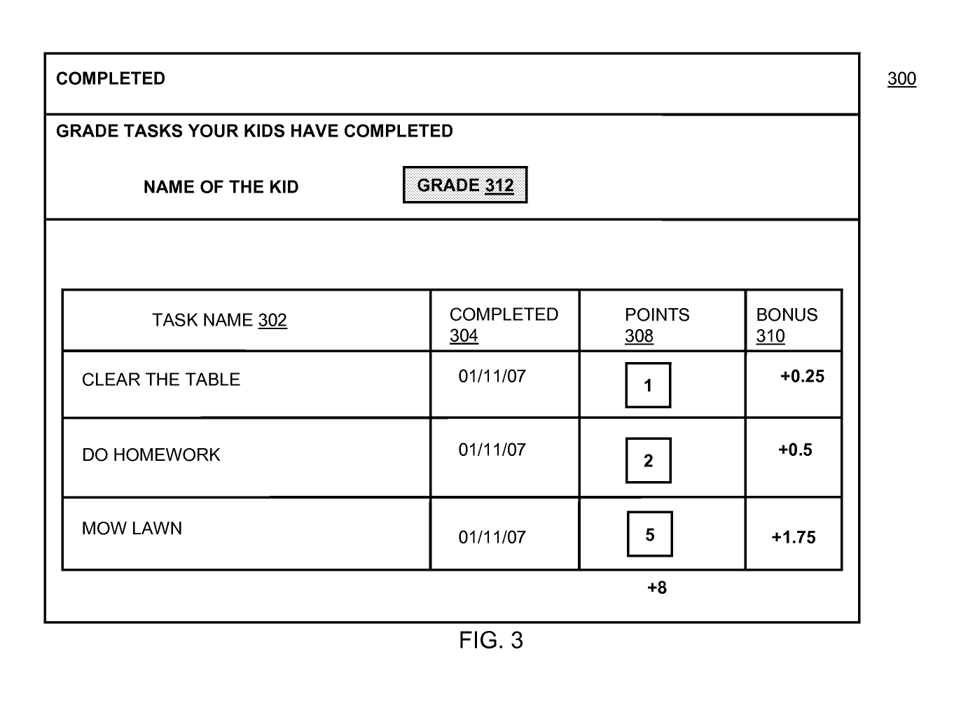

A user interface 134 for managers may comprise a Grade Tasks facility 154 for grading tasks that individuals may have completed. Points may be awarded once a task may be graded. Points may be deducted for not completing tasks in a timely fashion, satisfactory fashion, or at all. Points may also be deducted for poor behavior. Such points deductions may be reversed automatically when a task may be completed or at a manager's discretion. Referring to FIG. 3, the Grade Tasks facility 154 may comprise a list of task names 302, the date the task was completed 304, the number of points awarded for completion of the task 308, the number of bonus points 310 earned for completion of the task, and the like.

A user interface 134 for managers may comprise a Task History facility 164 to view tasks that have been graded, tasks that are complete but not yet graded, tasks that have not yet been completed, and the like.

A user interface 134 for managers may comprise an Options facility 150. The Options facility 150 may comprise Messages, such as notifications about graded tasks, approved rewards, dates on which tasks and rewards were completed and approved, and the like. The Options facility 150 may comprise a My Account facility to edit a user profile, a Logout button, and the like.

A user interface for managers may comprise a Reporting facility 168. The Reporting facility 168 may be used to generate reports on an individual's progress towards goals, generate reports on improvement or worsening in completing tasks over a selected time period, share reports with individuals or other managers, and the like.

A user interface 104 for individuals may comprise a Scoreboard 108, a To Do Management facility 110, a Rewards Choice Facility 112, an Internet facility 114, member newsletter 118, an Options facility 102, virtual world game facility 122, an E-Book facility 124, a Chat facility 128, a Front Page, and the like.

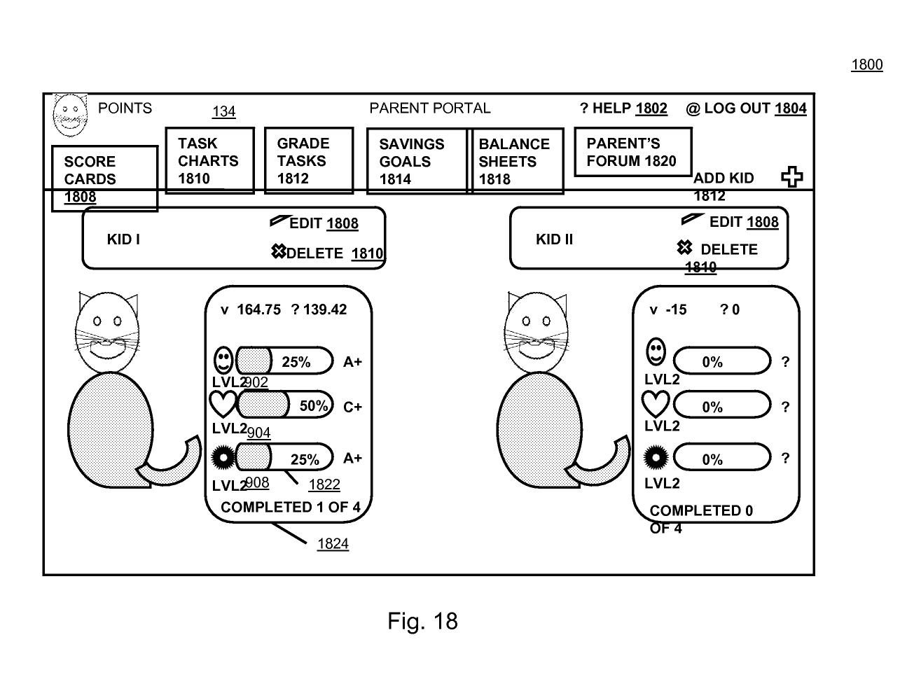

As shown in FIG. 18, the Scoreboard 108 may be displayed on a separate web page or displayed as part of an Individual's Home Page. The Scoreboard 108 and/or the Individual's Home Page may be the first web page seen when an individual may log in to the task management system 102. The Scoreboard 108 may display pending To Do items and assigned tasks. The Scoreboard 108 may display a points balance, bonus points, game tokens, pending points, recently approved points, rejected points, recently approved rewards, pending rewards, rejected rewards, and the like. The Scoreboard 108 may allow an individual to manage points and bonus points accumulation. The Scoreboard 108 may display a meter 1822 showing progress towards receiving a requested reward. The Scoreboard 108 may also display points deducted for not completing tasks in a timely fashion, satisfactory fashion, or at all, points deducted for poor behavior, potential points deduction reversals, and the like. The Scoreboard 108 may also display a Mission Status screen 1824. A mission may be a list of categories of tasks from which an individual may pick in order to complete the level. For example, a task category may be Schoolwork, Household Chores, Outdoor Chores, Be Good, Practice Sports, Extracurricular Activities, and the like. Each task category associated with a mission may have a quantity that specifies the number of tasks to do within that category in order to complete the level, for example, do any 5 household chores. The mission category may be customized when first setup. For example, a customization may be that completing the same task multiple times within a category may or may not count towards completion of the mission category. The Mission Status screen 1824 may display mission objectives and goals, and progress towards completion of the mission. The Mission Status screen may also display a grade meter, noting the average grade for completed tasks within the mission.

Continuing to refer to FIG. 18, the Points and Bonus Points Available and Pending scores may display in the upper portion of the score card. If there are no Pending scores and a message exists for recently graded tasks, then a message is displayed stating that an individual's pending scores have been recently graded where the Pending scores would appear. Once a message is displayed for new graded tasks, the message state may be cleared and deleted from the database. Weekly Allowance amount and Charity may display in a Rewards space. If an individual does not have a weekly allowance, then $0 displays in this area. If an individual does not donate to a charity, then “None” appears for the Charity. If new rewards were recently approved, then a message stating that the reward was approved will appear in this area. Once a message is displayed for new approved rewards, the message state may be cleared and deleted from the database. Clicking on the Rewards icon or the Allowance or Charity text may take an individual to the Rewards page where the individual may redeem rewards. A picture of a long term goal may be displayed. The progress bar 1822 shows how many points are needed to obtain the goal relative to how many points the individual has. If no long term goal is set, then the most expensive short term goal may be displayed. If no short term goals are set, then a message saying may be displayed recommending setting up a long term goal. Clicking on the reward image or name may bring the individual to the Rewards page where the individual may redeem rewards. The Mission Status panel may display a tabbed interface for displaying the individual's current progress through the Happy 902, Healthy 904, and Smart 908 missions. The top tab bar may display what Happy 902, Healthy 904, and Smart 908 levels an individual is currently on and which mission is currently selected. In order to complete a mission, an individual must complete X tasks in Y categories. The mission progress bar 1822 displays the total number of tasks completed across all categories (Z) compared against the total number of tasks required for all categories (X*Y). The percentage fill is calculated as Z/(X*Y). When individuals complete tasks, managers may assign a grade to the task or mark it as complete. The type of reward that an individual receives for completing a level may depend upon the individual's grade point average at the time of level completion. For example, if an individual scores a perfect score, then he/she receives a pack of 4 stamps plus 100 Bonus Points. If an individual scores 90%, then he/she receives a pack of 4 stamps, if 80% or above 3 stamps, etc. The tip of the progress bar 1822 displays the individual's average grade for the mission as he completes the mission tasks. The mission objectives may display up to four categories of tasks. Under each task category, may be empty slots representing the unique number of tasks that must be completed in order to advance to the next level. If an individual does a task within a category multiple times the task may be counted once towards mission completion, but the highest grade may be displayed and may be used for the grade point average. Hovering over a slot with a grade displays a tool tip of the task completed, date on which it was completed, and how many points and Bonus Points were received for the task. Clicking on the Hide button may hide the score card and mission status windows and reveal the entire background. Clicking on the Emoticon menu reveals the animation buttons. When the walk button is pressed the background scrolls horizontally.

The To Do Management facility 110 may allow an individual to create To Do and Reading list 504s to earn points, create a Goals list of rewards to save up for, mark progress towards saving up points towards a goal, mark progress of a task completion, mark tasks on a To Do list as complete for a manager to grade, and the like. The To Do Management facility 110 may display all charts created by the manager for an individual or by the individual themselves, such as a To Do Chart 828, a Chore Chart 830, a Behavior Chart 832, a Study Chart 834, a Health Chart 838, and the like. The To Do Management facility 110 may allow individuals to earn bonus points for tasks on a To Do list created by an individual or for any self-assigned task. In the display, different calendar views for the charts may be accessed from a drop down menu. For example, the Chore Chart 830 may be viewed by the current day, by a specific day, by a date range, by the current week, by the current month, by the year, and the like. The different calendar views available in the To Do Management facility 110 may be interactive. For example, the calendar may be marked with and searched for specific events in addition to the assigned tasks, such as Birthdays, historical events, holidays, parties, goals, and the like. To encourage individuals to explore the calendar and to learn about historic events, individuals may earn points or unlock game items for finding events within the calendar. For example, clicking on July 4th may display an animation video teaching the individual about Independence Day. After the video, the individual may be asked a couple of questions about Independence Day and may receive points or a special game prize for answering the question correctly. In another example, individuals may be given a list of events and icons representing the events that they must place correctly by date onto the calendar. Placing the events correctly may earn points and unlock game items.

The Rewards Choice Facility 112 may allow an individual to select rewards, redeem graded points for rewards on a Goals list, use Bonus Points to unlock secret codes, hidden cartoons, special prizes, and other items. The Rewards Choice Facility 112 may include a link to Go Shopping, access to My Shopping Cart, access to requests for a rewards catalog type, and the like. The ability to select rewards may be determined by a points balance, a type and/or number of tasks completed, and the like. The ability to purchase and listen to music may be determined by a points balance, a type and/or number of tasks completed, and the like.

The Internet facility 114 may allow an individual to request Internet website access, a specific website, and the like. The Internet facility 114 may display all sites bookmarked by a manager and pending approval by a manager. The Internet facility 114 may work with a browser plug-in 158 to implement a policy restricting access to the Internet.

The virtual world game facility 122 may allow an individual to play the virtual world game. The E-Book facility 124 may allow an individual to read an e-book. The Chat facility 128 may allow an individual to chat with other individuals, chat with a manager, and the like. A member newsletter 118 may display the number of total users and friends online, game hints and messages from other players, and the like. An Options Menu 120 may display Messages such as notifications about graded tasks and approved rewards, a Choose Colors Option to choose the color and font themes of the home page, a Choose Avatar Option, a Logout button, and the like. An Options Menu 120 may allow a manager to customize pop-up messages for individuals. An Options Menu 120 may allow a manager or an individual to customize the log-in screen for themselves or for the other.

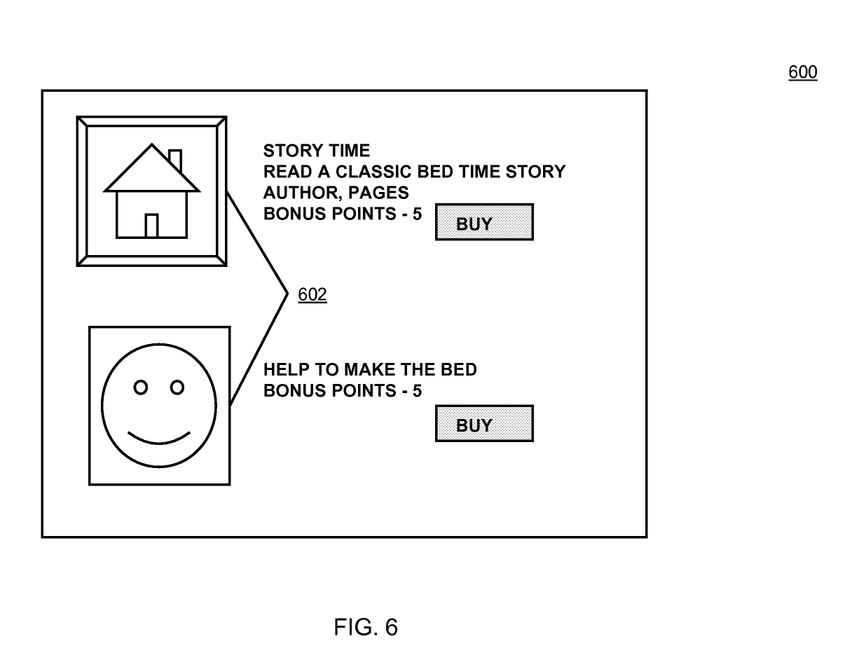

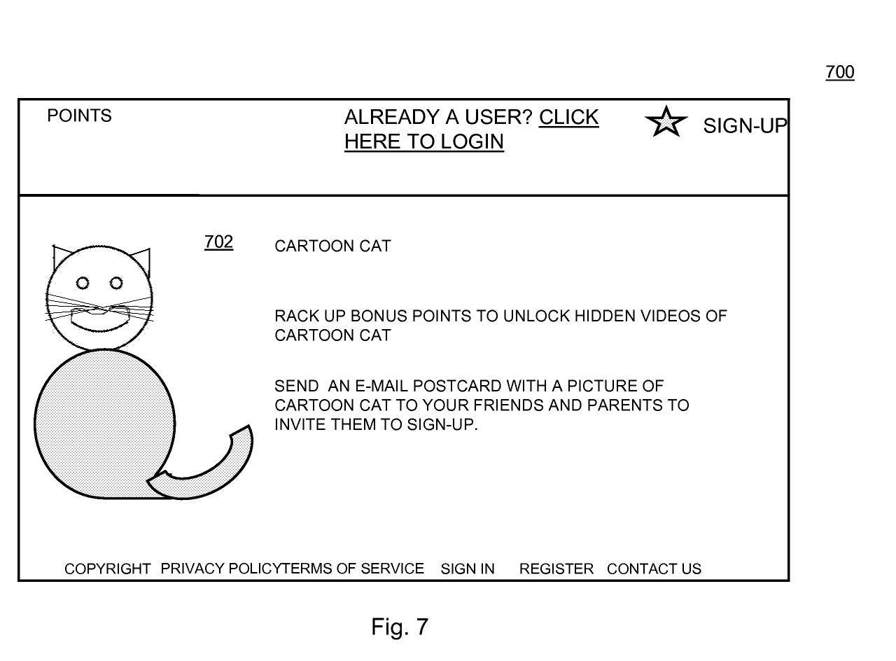

Referring to FIG. 6, a user interface for individuals may allow an individual to use Bonus Points to unlock cartoons, videos, and other fun stuff 602, such as Story Time, Petals Makes the Bed, and the like. The ability to view an online movie, video, or television show may be determined by the points balance, the type and/or number of completed tasks, and the like. Referring to FIG. 7, a front page 702 of an individual's homepage may be a cartoon such as an About Milo webpage.

In an embodiment, the task management system 102 may comprise a game. The game may be integrated with the To Do facilities 110, 140. Access to a game by an individual may be restricted by a manager. In an embodiment, an assigned task may need to be completed in order to gain access to game play. In another embodiment, an assigned task may need to be completed and graded in order to gain access to game play. For example, once a task has been completed and/or graded, an individual may have the ability to access game play through an individual user interface 104. In an embodiment, a manager may indicate a threshold number of tasks to complete, points to accumulate, or a combination thereof in order to gain access to a game. Tasks may need to be graded in order to qualify for the threshold. For example, a manager may indicate a certain number of tasks to complete for a particular day in order to gain access to a game. If an individual does not complete the required number of tasks for that day, they may not gain access to the game for that day. In another example, a manager may indicate that either a threshold number of points be accumulated or a threshold number of tasks be completed in order to gain access to game play. In this example, an individual may gain access to game play by completing a small number of high points value tasks or by completing a larger number of low points value tasks. Individuals may not have to redeem points to gain access to game play. In an embodiment, game play may be a reward for completion of tasks. A manager may indicate game play as a reward in a rewards catalog. Points may be redeemed for access to game play. In any event, the task may be from any of the To Do category charts or may be restricted to a particular category or categories of charts. For example, a manager may indicate that only tasks on a Chore Chart may qualify towards game play. Further, a manager may restrict game access by a password, to a time of day, duration of time, or by any other criteria or no criteria at all.

An individual may gain access to a game once they overcome any restrictions imposed by a manager, as described herein, or by seeking permission from a manager. The game may be an online game, a virtual world game 122, a networked game, a desktop game, a console game, a wireless game, a single player game, a multi-player game, an interactive game, a combination thereof, and the like. Points and/or bonus points earned from completing tasks may be converted to game tokens that may be used in a game. Game tokens may also be reverted to points.

An example of a game that may be associated with the task management system 102 may be a virtual world game 122, which may be similar to games such as The Sims™ and Second Life®. The task management system 102 may award game tokens to individuals for completing recommended tasks, reading recommended books, and the like. Alternatively, existing points and/or bonus points may be converted to game tokens when a game may be commenced or by request. The virtual world game may be integrated with the To Do facilities 110, 140. Game tokens may be used within the virtual world game to purchase clothing, in-store items, catalog items, pets, gadgets, and the like, to customize a character within the virtual world game 122, and the like.

The virtual world game 122 may be a Bonus Area for individuals. Access to the area may be restricted by a manager, by a points accumulation, by a Bonus Points accumulation, by a game tokens accumulation, by a time of day, by a password, any combination thereof, and the like. Individuals may earn game tokens through the To Do Chart by completing recommended tasks, reading recommended books, and the like. Game tokens may be used to purchase items within the virtual world game 122 such as clothing, gadgets to enable a character to perform special actions, furniture to change the appearance of a home, pets to adopt and care for, to change the appearance of a character, and the like. In an embodiment, players without a subscription may earn game tokens and browse store catalogs, however only paid subscribers may purchase items from the catalog.

Characters may navigate the virtual world game 122 as a single player game, as a multi-player game, an online game, a desktop-based game, an interactive game, a wireless game, and the like. Characters may enter other characters' homes, view objects, chat and/or view other players, and the like. Features of the game may include game tokens from chores, Hidden items in a To Do Chart 828, Level meters, character personalization, character Homes, Home Personalization, Visit other characters' homes; rate other characters' homes, Stores, Profile integrated with To Do Chart 828, a member newsletter 118 featuring Coolest Home contests, Map, Rooms/Stores, neighborhoods, Chat, Character Profile, Rate Character, Friends and Ignore List, Reporting Bad Characters, Game Servers, Gadgets, Pets, Movies, Books, Postcards, and the like.

When starting a new account, individuals may pick the type of character they would like to be within the game. Individuals may pick from character types such as animals, historical figures, comic book characters, athletes, entertainers, custom characters, themselves, and the like. For example, the game may comprise a cast of feline characters. The feline characters may be chosen from the group consisting of Abyssinian, Siamese, Birman, Cornish Rex, Bombay, American Wirehair, Bengal, Chartreux, Pixie Bob Kitten, Somali, and the like. Individuals may use game tokens to purchase additional character types, such as, continuing with this example, Persian, Himalayan, Javanese, Norwegian Forest Cat, Balinese, Laperm, Sphynx, Snowshoe, Bombay, British Shorthair, and the like. At any time during the game, both free and subscription account holders may change their character.

Individuals may save up their game tokens to purchase clothing to customize their characters. Clothing items may be grouped into categories such as Eyeglasses, Hats, Shirts, Pants, Shoes, Tail accessories such as rings, feathers, glitter, tattoos, and Costumes combining any of the above, and the like. To change the appearance of one's character, an individual may select the Clothes icon on the main game menu to bring up a selection window displaying the character's profile, name, and selection list of bought clothing items.

Individuals may purchase clothes for their characters by browsing the clothing catalog. Clothing articles may be organized into two types: Customizable and Fixed. Customizable types of clothing allow individuals to select the primary color of the article when dressing up their characters. Customizable clothes may be assigned a default color when displayed in the catalog and worn by a character. Fixed clothes may not allow for color customization. Clothes may be organized by season and style and browsed like a clothing magazine. Each clothing article contains a name and bonus points price. Costume items may be shown together and must be purchased as a set. When an individual selects the buy button, a dialog displays confirming the sale. Upon purchase, the bonus points price may be deducted from the individual's bonus points balance and the clothing article appears inside the character's Dressing Room. The Dressing Room allows individuals to change their character type, such as to a different cat breed, clothes and color of customizable clothing.

Each character and clothing article may support animations, such as Idle, Confused, Cry, Laugh, Sleep, Sneeze, Whistle, Cheer, Dance, Eye Roll, Duck, Peek, Hiccup, Wave, Walk, and the like. For example, hand items should all support the idle, sleep, whistle, eye roll, and walk animations. The hand items may be layered as the top most layer, so that each hand item can support custom animations, such as wand flips into air on sneeze.

In addition to earning game tokens, individuals may do chores in order to determine the status of their characters within the game. A character may have level meters such as Happy 902, Smart 904, Strong, and Healthy 904. The value of each level meter may be determined by how many and how often an individual completes tasks within his/her To Do Chart 828. Points-earning tasks may be organized into categories that map to a specific level meter such that each level may have unique task requirements for fulfilling the level. For example, tasks mapping to a Happy level meter may be Be Good, Demerits (deducts happiness), Be Clean, Pet Care, and the like. For example, tasks mapping to a Smart level meter may be Recommended Books, Be the Best, Schoolwork, and the like. For example, tasks mapping to a Strong level meter may be Household Chores, Outdoor Chores, Be Healthy, Other, created by a parent or manager, and the like. A level meter may track the progress of a character in reaching the next game level. For example, a character who is level 3 Smart may be trying to reach level 4 Smart. Each level may have unique task requirements for fulfilling the level. For example, in order to reach level 4 Smart, an individual must read 5 recommended books and make honor roll for the quarter. As an individual marks tasks off in the To Do Chart 828, the level meter advances as the individual gets closer to reaching the next level. Once filling the level requirement, the character may receive a trophy and a special game item for reaching the level.

Messages may be displayed upon advancing level, earning points, having points or rewards approved, and the like. For example, a Happy 902, Smart 908, or Healthy 904 Level Up Message, a Points Awarded Message, Points Pending Message, or Reward Approved Message may trigger an animation and show a dialog displaying what the individual may have won, such as a trophy, game item, and the like, or been rewarded.

Alternatively, once filling the level requirement, an individual may receive a pack of collectables to place inside his/her collectable book. Each level may have a mission associated with the level, as described herein.

When an individual may be assigned a task to complete, the manager or the task management system 102 may determine the maximum number of points awarded. Further, a manager or the task management system 102 may decide a maximum number of Bonus Points amount for an A+. When a task may be completed, a manager may assign a letter grade to the task. The letter grade may determine the amount of points and bonus points awarded for fulfilling the task. For example, a grade of A+ may result in an individual receiving 100 bonus points, 95 for an A, 90 for an A−, 88 for a B+, 85 for a B, 80 for a B−, 78 for a C+, 75 for a C, 70 for a C−, 68 for a D+, 65 for a D, 60 for D−, no bonus points for a failing mark, and the like.

In order to complete a mission, an individual may have to complete X tasks in Y categories. The type of reward an individual may receive for completing a level may depend upon the individual's grade point average at the time of level completion. For example, if an individual scores a perfect score, then they may receive a pack of 4 collectables plus 100 Bonus Points. An example of a Smart Mission may be as follows, get straight A+'s when doing specific tasks and receive a pack of 4 collectables and 100 Bonus Points, where the specific tasks may be reading a number of books, participating in a number of extracurricular activities, completing a number of schoolwork assignments, practicing an instrument a number of times a day, and the like.

Every character may live in a house. Subscribers may have the ability to decorate their house by buying different furniture and home decorations such as: couches, love seats, chairs, dining room table, chairs, desks, lamps, television, radio, plants, air hockey table, video arcade machine, foosball table, or the like. Once a furniture item may be purchased, the item may appear in the Furniture menu. The player may select the furniture item from the menu and use the mouse to drag the item to its desired location within the room. Once a furniture item has been placed within a room, a player may select the item triggering a popup dialog displaying a picture and description of the item and how many other individuals own the item. If the individual is the owner of the item, then the individual may have the option to remove the item from the room.

Each character may start out with a basic one-room house. Subscribers may have the option of upgrading to different houses as they earn more game tokens. After changing houses, all of the character's items in the old house may be transferred into the new house. When characters visit each other's houses, they may rate the house on a scale of 1 to 5 stars. The houses with the highest star ratings may be featured in the member newsletter 118 each week. Houses may also be ranked by how clean they are. A house may become dirty when an individual may forget to mark their chore charts for a given time period. The total number of days that a chore is overdue may be counted as a dirty day. Spotless houses may be featured in the member newsletter 118.

Gadgets may be accessory items that characters may use to perform special actions within the game. For example, a red skateboard may enable the character to do an ollie kickflip and a water gun lets the character shoot water at other characters. To use a gadget, individuals may select the gadget from the Gadgets menu on the main game menu. Selecting the gadget may trigger an animation action associated with the gadget. For directed actions, the game cursor may change into a transparent bulls-eye prompting the user to select the direction at which the action will occur.

Characters may purchase pets at the pet store. Pets reside at the character's home and need to be fed and require attention and love from their owner. A character may buy food, snacks, and toys for its pet. If an individual feeds the pet too many snacks, it will eventually get sick and not be able to eat either snacks or healthy food. If an individual does not play with the pet, the pet will become grumpy. If the pet is not fed or played with for too long, the pet will run away. Characters may choose a pet from the amongst a group of pets, such as Furry Critters such as mice, hamsters, gerbils, ferrets, cats, and dogs; Fish such as gold fish, angel fish, and trout; Birds such as canary, parrot, owl, and the like.

Characters may find hidden items within the To Do Chart 828. Game items may be randomly given to an individual who complete assigned and/or recommended tasks. For example, every tenth individual who washes the dishes today may receive a special edition baseball cap to dress up their character within the game.

Stores may exist within different locations in the application. When a character enters a location that contains a store, the individual may be presented with the store's catalog. The catalog and selection of items available to an individual may be determined by a game level, a points or game token balance, the types and number of tasks completed, and the like. Individuals may browse the store catalog and click on an item's buy button to purchase the item using one's game points. The inventory of a game item purchased using an individual's points or game tokens may be limited to a specified amount. The amount may be specified by a game monitor, a manager, and the like. Each store may have a limited inventory of each item contained in the catalog. The catalog displays how many of the items are left to purchase. Once an item has sold out, no other characters may purchase the item. Game items may be traded by characters. The ability to trade a game item with another character may be determined by a game level, a points or game token balance, the types and number of tasks completed, and the like. New items and inventory may be introduced dynamically to a store catalog and stores may discontinue selling an item. The look and feel of the store catalog may be changed to match the season and theme of the items being sold, i.e. “Spring 2007 Cat Walk Collection” would contain limited availability high fashion accessories.

Auctions may be special types of stores that allow characters to sell items that they own to other characters. When characters enter an auction, they may bid on items in the auction catalog or they may place items for sale. When selling an item, characters may specify a minimum bid amount and how long they want the auction to last. When an auction closes, the object may be automatically transferred to the winning character and the selling and buying characters may be sent an email notification of the sale. An abbreviated notification may also occur within the game, whereby a chat balloon displaying the message appears above the main game menu.

When entering the movie theatre, characters may select from a menu of free videos, bonus videos and movie trailers to watch.

Characters may choose to deposit their points or game tokens into a savings account at the local bank. Interest may be earned on the points and/or game tokens. Different interest rates will be offered to characters based upon the amount of points and/or game tokens and length of time that the character chooses to save, such as Deposit 100 points, get 110 points after 10 days; Deposit 100 points, get 130 points after 20 days; Deposit 100 points, get 200 points after 50 days, and the like. When a character deposits game points into the bank, he/she may not use the game points until after the savings time period has expired. In an embodiment, only paid subscribers may deposit points into the bank. In an embodiment, the ability to deposit points and/or game tokens may be determined by a game level, a points or game token balance, the type and/or number of tasks completed, and the like.

Characters may broadcast messages to other characters in the same room using a chat server 160. Individuals may type their message into the chat text field and press the return key or send button to send the message. Sending a chat message may display a bubble above the character displaying the message. The message may also be displayed on the global chat drop down text area at the top of the screen. The global chat text area, displays all messages in linear format similar to an IM client. In addition, individuals may select from emoticons or a menu of popular phrases such as Yes, No, OK, Follow me, Look over there, etc. Chat transcripts for each player may be saved and monitored by mediators when a player may be reported.

Rooms may be the main areas in which characters may meet and talk with other characters. Rooms connect with other rooms and provide the landscape for entering stores. Neighborhoods may be top-level rooms that may be displayed on the game map. There may be secret rooms hidden through out the game that may require characters to take a specified path through adjacent rooms.

Characters may move within a room by using the mouse to point and click to where the character should move. Characters may not move through inanimate objects within a room. Moving a character over an entry point to a store displays the store catalog. Characters may teleport to different neighborhoods by displaying the Map from the main game menu and selecting the desired neighborhood on the Map.

The member newsletter 118 may be a monthly magazine that all characters subscribe to. The member newsletter 118 displays articles about new features, the latest fashion trends, home decoration tips, and answers to user questions. Characters may read the latest member newsletter 118 by selecting the member newsletter 118 icon on the main Game Menu. Users may also find past issues of the member newsletter 118 in the library and on the bookshelves and tables of various rooms. Characters may also find books on the shelves and tables of different rooms. Characters may read the books and member newsletter 118 by clicking on the book or member newsletter 118. Books may contain stories and pictures of famous fictional and non-fictional characters based on real life.

In an embodiment, a character's profile may be a close-up picture of the character wearing his/her purchased clothing and accessories. A character's profile may display as part of the Scoreboard within the To Do Chart 828. Within the game, clicking on a character within a room may display a popup window displaying the character's profile. From the character's profile menu, a character may be added to a friends list, ignored, sent a postcard, reported for bad behavior, rated, and the like. Each character's Smart 908, Happy 902, and Strong level may appear as part of his/her profile. In addition each character may have a character rating. When viewing a character's profile, an individual may rate the character on a scale of 1 to 5 stars. The highest-rated characters may be featured in the member newsletter 118 each week.

When an individual adds a friend to a friends list, a message may be sent to the friend asking him/her whether it is ok to be friends. A message icon may appear in the top left corner of the target friend's screen. If the player accepts, then each character will be added to each other's friends list. Players access one's friends list by selecting the Friends menu item from the Game Menu. When selecting a friend from the friends list, the friend's profile dialog may be displayed. An individual may find out where a friend is within the game by selecting the Where icon in the Profile dialog.

Ignoring a character may add the character to a player's ignore list. Characters on a player's ignore list may be blocked from seeing the player's profile and adding the player as a friend. Players access one's ignore list by selecting the Friends menu item from the Game Menu and then selecting the ignore list from the submenu on the Friends List dialog.

Selecting the Postcard icon on a character's profile displays a catalog of postcards that a character may purchase to send to another character. Examples of postcards may be ‘Welcome To the Cool Character's Club’, ‘Get Well Soon’, ‘I Like You’, ‘Will You Be My Friend’? ‘I Think You're Cool’, and the like. When a character may receive a postcard from another character, a postcard icon may display in the top left corner of the screen. Selecting the postcard icon may display the postcard.

Reporting a character for bad behavior may flag a player's account to be monitored. A report may be sent to a manager or a game monitor with the logs of the character being reported. If a player is found to be breaking the rules, the character's account may be disabled, the player's manager may be notified and the player may be banned from the game.

When logging in, characters may select a game server 162 in which to play. A game server 162 may support a fixed limit of characters. Characters may only see friends and other characters who are on the same game server 162.

A Game Menu may comprise menu items such as Gadgets, Emoticon, Popular Phrases, Chat, Friends, Map, Clothes, Furniture, Home, Member Newsletter 118, Messages, Postcard, and the like.

A navigation map may comprise geometric shapes representing neighborhood rooms that may be accessible from the Map on the main game menu. For example, white rectangles may represent normal rooms and green half-circles may be rooms in which shops or auctions reside. Blue ovals may be mini-games. Arrows may represent bi-directional connection points between rooms. Exemplary neighborhood rooms will now be described.

In an embodiment, the neighborhood may be a beach. Entering this neighborhood may bring the player to a sunny beach with umbrella stands, beach volleyball, and characters surf boarding. Characters may sit under empty umbrella stands, sun themselves, sip on drinks, make sand castles, and talk with other characters. Characters may pick up beach balls and throw them at other characters. On the right side of the screen, characters may be surfing on waves rolling into the beach. On the top right corner may be a cliff where characters may be jumping into the ocean. At the foot of the cliff may be a beach cave. Directing a character to the cliff enters the Sea Cave room. Exiting the bottom right corner may enter ‘The Country’.

In an embodiment, the neighborhood may be a ‘Sea Cave’. In the sea cave may be stalactites and stalagmites, crashing waves entering the cave, and pirate warnings and a treasure map painted on the walls. To the left in the distance may be an abandoned pirate ship. Exiting to the right enters the Beach and exiting to the left may enter a Pirate Ship.

In an embodiment, the neighborhood may be the Pirate Ship. This room may be the deck of an abandoned pirate ship. On the deck of the pirate ship may be jugs of rum, canon balls and canons, and a skeleton of a dead pirate. Moving over cannon enters the Sink™, the Ship Mini-game. Moving over a jug of rum may direct a character to pick up the jug, drink from it, and then wobble around drunk for a few seconds. Exiting to the right of the screen may enter the ‘Sea Cave’.

In an embodiment, the neighborhood may be ‘The Country’. Entering this neighborhood brings the player to a country farm-house setting with a gravel road, fenced flower fields, a barn, and pasture with cows in the distance. Exiting to the bottom left may enter The Woods.

In an embodiment, the neighborhood may be a Pasture. This room may be a pasture with cows that moo and graze. Cow patties and grasshoppers may be found walking within the pasture. If a character walks on a cow patty, the character may make a yucky face and the cow patty squishes and emits a green odor. At the right end of the screen may be a tractor. Touching the tractor enters the Tractor Race Mini-game. Exiting to the right may enter the barn.

In an embodiment, the neighborhood may be a Barn. This room may be the inside of a barn with a hay bin loft and stalls for horses, pigs, and goats. In front of one of the stalls, may be a hand painted sign: “Adopt a Pet.” Entering the stall displays the Pet Catalog with the following choices: Yellow Chick, Field Mouse, Cat, Dog, and the like.

In an embodiment, the neighborhood may be ‘The Woods’. Entering this neighborhood brings a player to a forest setting with redwood trees, dirt paths, and blackberry bushes. At the center of the screen may be a giant redwood tree with a rope ladder leading up the tree. Moving to the base of the tree enters the Tree House. On the left of the tree with the ladder may be a tree with vines. Moving over the vines may enter the Vine Swing Mini-game.

In an embodiment, the neighborhood may be a Tree House. This room may be a tree clubhouse setting with wooden floors, box carts for chairs, and crayon drawings or signs tacked on the tree trunks that pillar the tree house. The right side of the tree house may open up to a skyline view of the game world. On the left edge of the tree house may be a vine. Grabbing the vine may enter the Vine Swing Mini-game.

In an embodiment, the neighborhood may be ‘The City’. Entering this neighborhood may bring you to a busy city street. To the left may be a traffic circle with characters in cars honking and a resident character dressed in a police uniform directing traffic. The horizon may be lined with tall buildings and a clock tower that shows the current game time in the time zone of the individual, the location of the game server, both, and the like. The buildings may include a Bank, C-Bay Auction and Gadget Shop. Exiting to the left may enter the Beach, to the right may enter the Burbs.

In an embodiment, the neighborhood may be a Bank. This room may be the inside of a bank. The top of the screen may be lined with resident characters dressed as bank tellers behind bank teller stations. There may be a large safe in the background and a security dog walking about in the foreground. Approaching the teller may display a dialog box with the loan menu options to purchase different savings bonds: Deposit 100 points, get 110 points after 10 days; Deposit 100 points, get 130 points after 20 days; Deposit 100 points, get 200 points after 50 days, and the like. Exiting the bank may place the character in the City.

In an embodiment, the neighborhood may be a C-Bay Auction This room may be the inside of a C-Bay Auction. On the shelves, display cases, and aisles of the shop may be various gadgets, jewelry, racks of vintage clothing, and appliances. The top of the screen may be a retail counter with a tattooed, leather clad resident character wearing ear rings and a mohawk. Approaching the resident character may trigger the auction catalog where a player may place his items for sale or bid on existing items. Exiting the C-Bay Auction may place the character in the City.

In an embodiment, the neighborhood may be a Gadget Shop. This room may be the inside of a gadget shop. The inside of the shop may resemble a new age electronics shop with neon lights and flashing video displays advertising the latest gadgets and tricks. Working the counter of the gadget shop may be a resident character. Approaching the resident character may trigger the store catalog where a player can purchase the following gadgets: Red Skateboard: character does an ollie kick-flip; Blue Skateboard: character does a handstand trick; Dishray Gun: character shoots soap bubbles at target; Blue Weather Dust: character throws pixie dust at area and makes it rain above area; Green Weather Dust: character throws pixie dust at area and makes it snow above area; Hula hoop: character plays hula hoop; Basketball: character dribbles basketball; Spring loaded shoes: character jumps high; Pogo stick: character jumps on pogo stick; Blueberry pie: character throws blueberry pie at target; Chocolate cake: character eats cake; Ice cream cone: character eats ice cream; Fire baton: character juggles fire baton; Balloons: character holds balloons; Instruments: horn, guitar, marching drum, and the like: character plays instrument; and the like.

In an embodiment, the neighborhood may be ‘The Burbs’. Entering this neighborhood may bring the player to a suburban strip mall. There may be a row of shops, a movie theatre and several restaurants. Exiting to the left may enter The City and exiting to the right may enter the School.

In an embodiment, the neighborhood may be a character clothing store. This store may resemble a conventional clothing store with mannequins and posters modeling the latest fashions and display stands with folded clothes and standing racks with hanging jackets, slacks, and shirts. Moving to the center display stand may bring up the clothing catalog with selections such as Night on The Town, Top Hat, Cane, Tuxedo, Suit and Tie, Evening Gown, Sequined Party Dress, Heels, Diamond Tail Ring, On the Farm, Straw Hat, Sunflower Hat, Sunflower Dress, Trousers, Working Boots, Purple Haze, Tie Dye T-shirt, Tie Dye Dress, Sandals, Feather tail extension, On The Beach, Bikini, One piece swimsuit, Snorkel mask, Flip-flops, Flippers, Swim-trunks, Oversized sunglasses, Just For Fun, Tennis Outfit, Fruit Hat, Mustache, Studded tail ring, Fireman's hat, and the like. Exiting the character clothing store may place a player in The Burbs.

In an embodiment, the neighborhood may be a Home Store. This store may resemble a store with home items and furniture displayed throughout the store. In the center of the store may be a cash register and a resident character sales attendant. Moving a character to the cash register may display the furniture catalog with selections such as Green collection: Couch, Loveseat, Arm chair, Coffee table, Lamp; Pink collection: Couch, Loveseat, Arm chair, Coffee table, Lamp, Kitchen, Refrigerator, Kitchen table and chairs, Range, Study, Bookshelf, Computer desk, Computer, Fun, Dollhouse, Foosball table, video game system, Décor, Violet house plants, Red flower vase, Starry Night by Vincent Van Goat, Tinkerbell Soup by Andy Warthog, and the like.

In an embodiment, the neighborhood may be a Movie Theatre. This room may be the lobby of a movie theatre with a concession stand and life size standouts of current movies, e.g. Spider Cat V and Dogs, The Musical. A resident character wearing a candy-striped outfit may be working the concession stand handing out candies and popcorn. To the right and left of the concession stand may be entrances to the movie theatres with the title of the movies above the entrance, such as “Nine Lives or Die Hard”, starring Bryce Willis and “Ratalicious” starring Milo as Rizo the Rat. Entering the movie theatre may bring up a video window showing a movie trailer of the featured movie. After the trailer may be done, players may select from a catalog of past movie trailers and bonus videos.

In an embodiment, the neighborhood may be ‘The Schoolyard’. Entering this neighborhood may bring you to an outdoor schoolyard scene with a playground and basketball court. The horizon of the scene may be set with a school building with entrance points to the cafeteria, library, and science lab. Exiting to the bottom of the screen may enter The Neighborhood.

In an embodiment, the neighborhood may be a Library. This room may be a school library setting with bookshelves, circular tables, multi-colored chairs, computer desks, AV cart with TV. Characters may select the bookshelves to read different books, such as Cat Sawyer: parody of Tom Sawyer, Furry Potter and The Goblet of Milk: parody of Harry Potter, Little Red Riding Kitty: parody of Little Red Riding Hood, and the like. Moving the character to the top of the screen may exit to the Science Lab, to the left to the Schoolyard, to the bottom to a Cafeteria.

In an embodiment, the neighborhood may be the Cafeteria. This room may be a school cafeteria setting with long tables and multi-colored chairs. Characters may sit on empty chairs at a table. When sitting at a table, characters may eat from a cafeteria tray or a bagged lunch and may talk with other characters. The horizon of the cafeteria scene may be the lunch line with resident characters dressed in hairnets serving lunch plates. Selecting the cafeteria line at the top of the screen prompts the user to play Sloppy Joe's Mini-game. Navigating to the left of the screen may enter the schoolyard, navigating to the right may enter the Library.

In an embodiment, the neighborhood may be a Science Lab. This room may be a school science lab setting with a long lab desk containing beakers and vials of bright colored chemicals and scientific equipment. There may be a life size skeleton of a character and posters of the periodic table and universe. When a character may sit at an empty chair at the lab table, the character may begin mixing different chemicals that may cause a chemical reaction and small puff of smoke to appear. Exiting the left of the screen may enter the Schoolyard, and exiting the bottom of the screen may enter the Library.

In an embodiment, the neighborhood may be ‘The Neighborhood’. This room may be a suburban neighborhood with white picket fences, groomed lawns, sidewalks, street lamps, sign posts, nicely painted houses of different shapes and sizes, and the like. Resident characters may ride on bikes delivering newspapers and drive milk trucks delivering milk. Entering a home may display a dialog box asking the user to select which character's home they may wish to visit.

An example of a game that may be associated with the task management system 102 may be a collection game, such as a collecting, matching, and trading game. Items in the collection game may be collected, matched, traded, and the like. Collectible items may be trading cards, stamps, real world items, such as marbles, dolls, toys, and the like, videos, virtual pets, virtual insects, virtual characters, and any item that an individual may collect, trade, and/or match. Collectible game items may be won by an individual for advancing to the next level of the virtual world game 122 or the level meter. The collection game may facilitate motivating an individual to work towards achieving a next level in the virtual world game 122 or level meter associated with a To Do Chart.

In an embodiment, the collectible item may be a trading card or stamp. The artwork may depict a real world item, a character, a celebrity, an athlete, a musician, a pop culture icon, people, places, board games, and the like. The artwork may be framed with a card or stamp framing. Each collection of cards or stamps and each individual card or stamp may have a detailed description teaching the individual about the significance and history of the collection or individual item. Cards or stamps may differ in themes that may be determined by the level type. For example, cards or stamps associated with a Happy level may be related to Entertainment, Culture, Recreation, and the like; cards or stamps associated with a Smart level may be related to Science, History, and the like; and cards or stamps associated a Healthy level may be related to Food, Fitness, Sports, and the like. Each theme may also contain sub-themes that form collections of different game items. For example, within Healthy Foods, there may be collections, such as Fruit, Vegetables, Italian Foods, American Foods, Chinese Foods, and the like.

In an embodiment, individuals may win new cards or stamps. When individuals advance within a level, they may receive a pack of cards or stamps within the level's theme that may span multiple collections. This may allow the individual to acquire different collections of cards or stamps based upon different sub-themes. For example, when Jane advances to level 5 healthy, she may be awarded a card or stamp book containing: Lime, Green Pepper, Lasagna, Mac N Cheese, and Kung Pao Chicken. To make the game of collecting fun and engaging, the individual may be intelligently presented with different cards or stamps. Each card or stamp may have an inventory weight that determines the frequency by which it may become available for collection relative to other stamps across all collections.

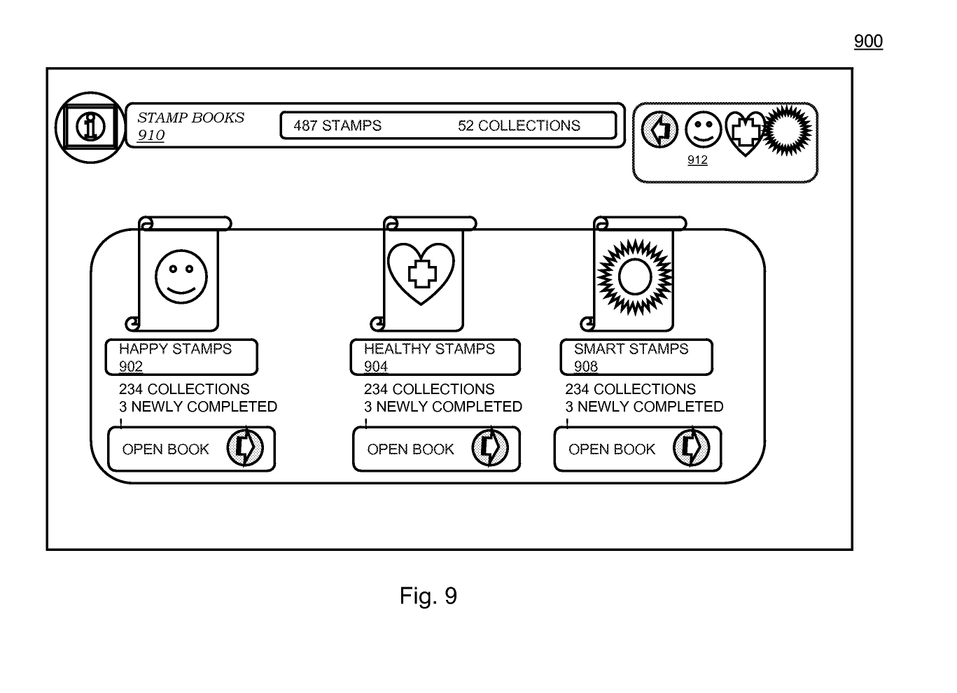

Each individual may have a Happy 902, Healthy 904, and Smart 908 card or stamp book as shown in FIG. 9 that stores the collection of cards or stamps that they own within the game. After winning a card or stamp pack, individuals may “open” their card or stamp pack and play a matching game to place the card or stamp within the appropriate spot within the card or stamp book. When opening the pack, kids may only see a thumbnail picture of the card or stamp. Once a card or stamp is correctly placed within a book, the card or stamp's full image, description, rareness, and ownership statistics may be unlocked. Individuals may own multiple copies of the same card or stamp. Individuals may be able to trade cards or stamps with other individuals to fill out their collections.

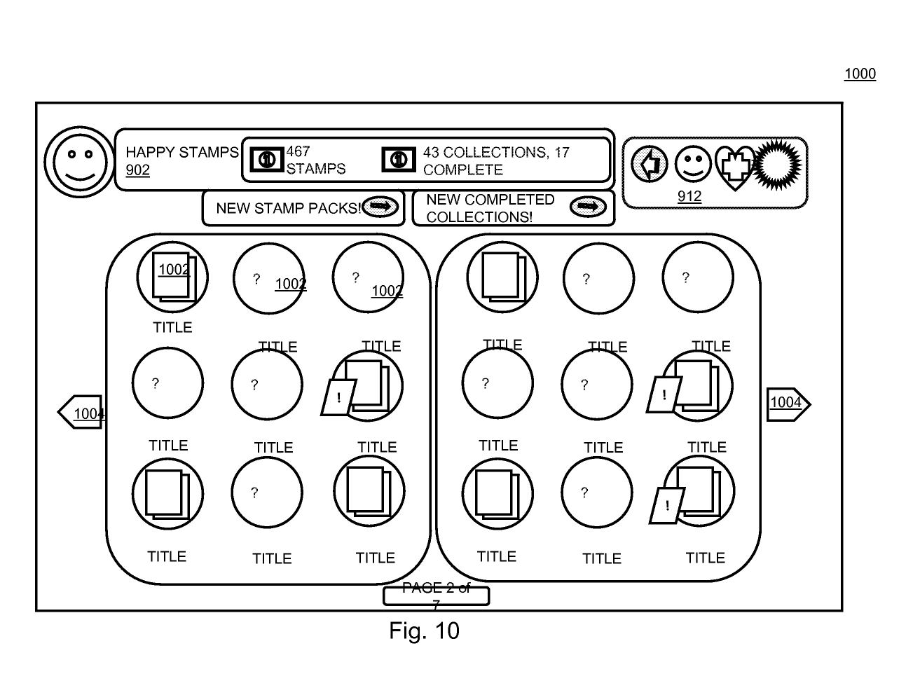

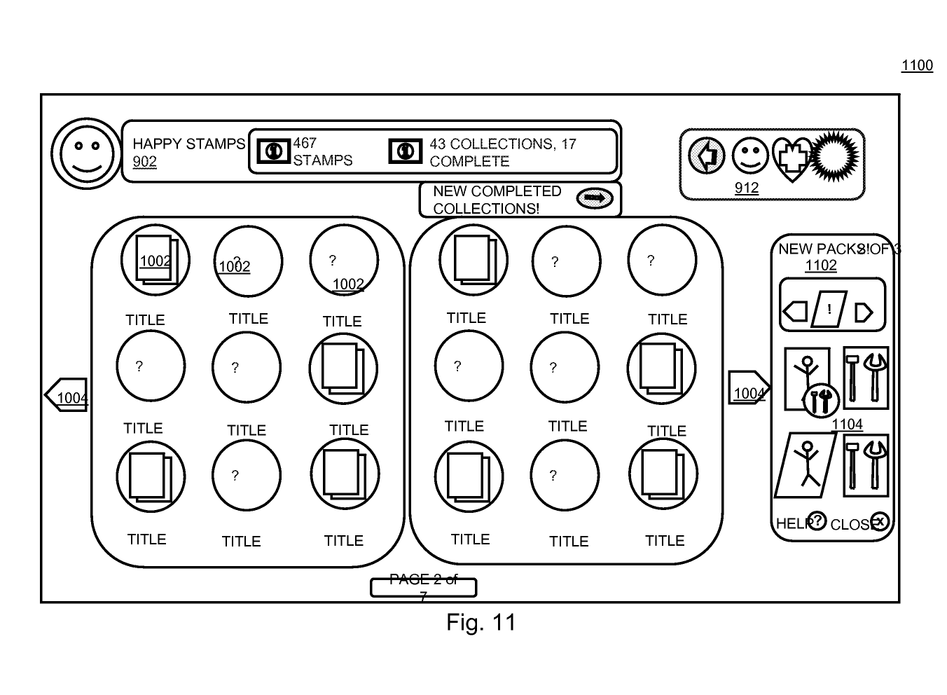

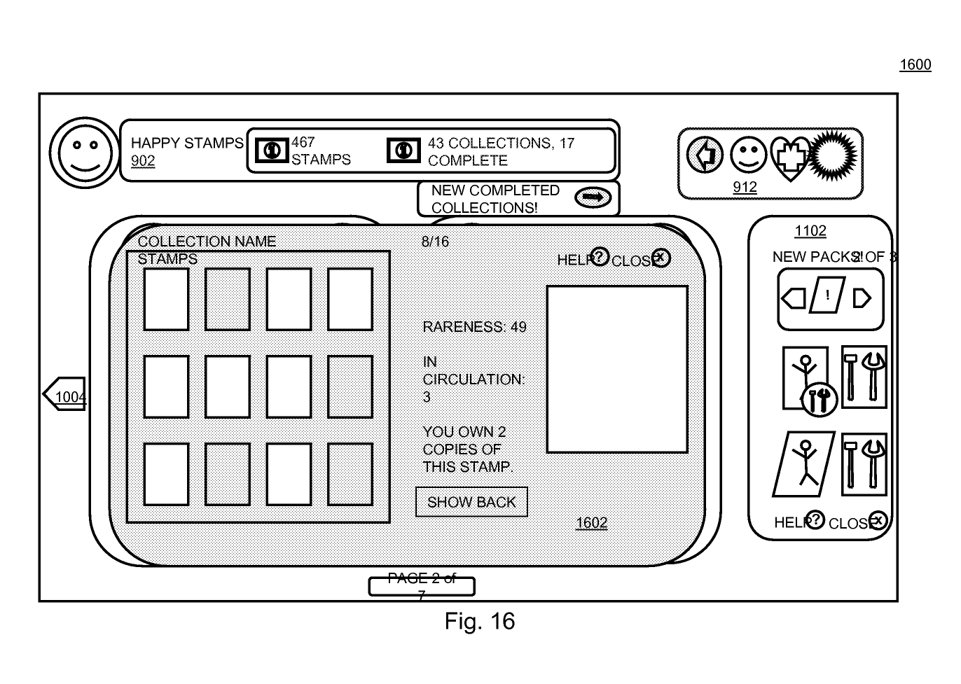

Referring to FIG. 9, stamp book's main menu may allow individuals to browse stamp books 910. While this figure and FIGS. 10 through 17 depict an embodiment of the collection game comprising stamps, any collectible item may be substituted in its place, such as trading cards, videos, real world items or a representation thereof, virtual characters, and the like. An individual may choose a stamp book to browse, such as Happy stamps 902, Healthy stamps 904, Smart stamps 908, and the like. Individuals may access quick links to open new stamp packs or browse newly completed collections. When selecting the newly completed collections link, a drop down menu may appear displaying a list of collections. Selecting a collection may allow the individual to jump to the page in the stamp book containing the collection and opens the collection's contact sheet 1602, as in FIG. 16. Selecting the New Pack Earned link may open the stamp book and bring up the New Packs menu 1102, as in FIG. 11.

Referring to FIG. 10, each collection may have a unique icon representing the collection 1002. Collections 1002 may be listed in alphabetical order, by theme, by size, and the like. A “new” badge may indicate that the collection 1102 is new, such as a collection for which it may be less than 3 weeks since it was created. A “completed” badge may indicate that the collection is complete. An individual may scroll through collection pages by selecting the left and right arrows 1004 and go back to the main stamp home page or jump to a different stamp book using a navigation menu 1008. The navigation menu 1008 may be disposed in the upper right corner of the stamp collection page 1000. Selecting a stamp collection may bring the individual to a stamp collection page 1000, as in FIG. 16. Selecting the New Stamps Packs callout may bring the individual, such as in FIG. 11.

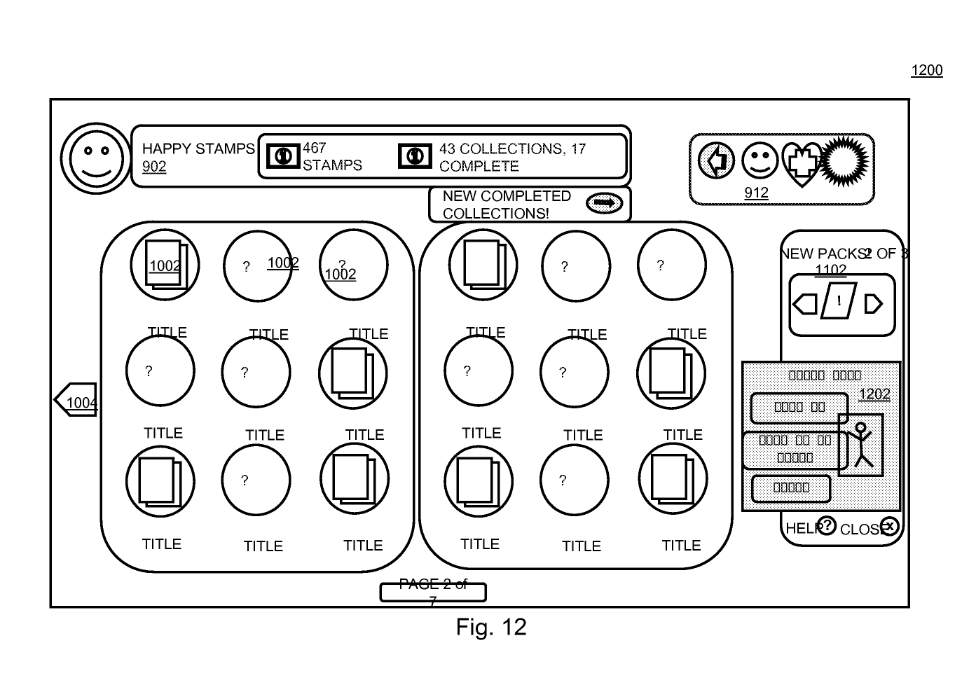

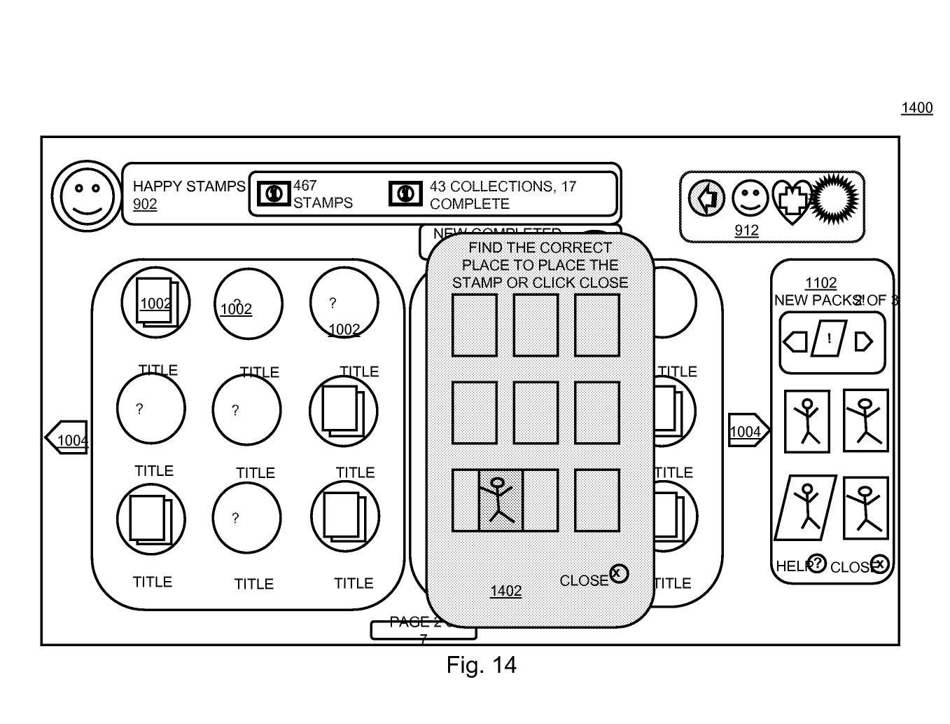

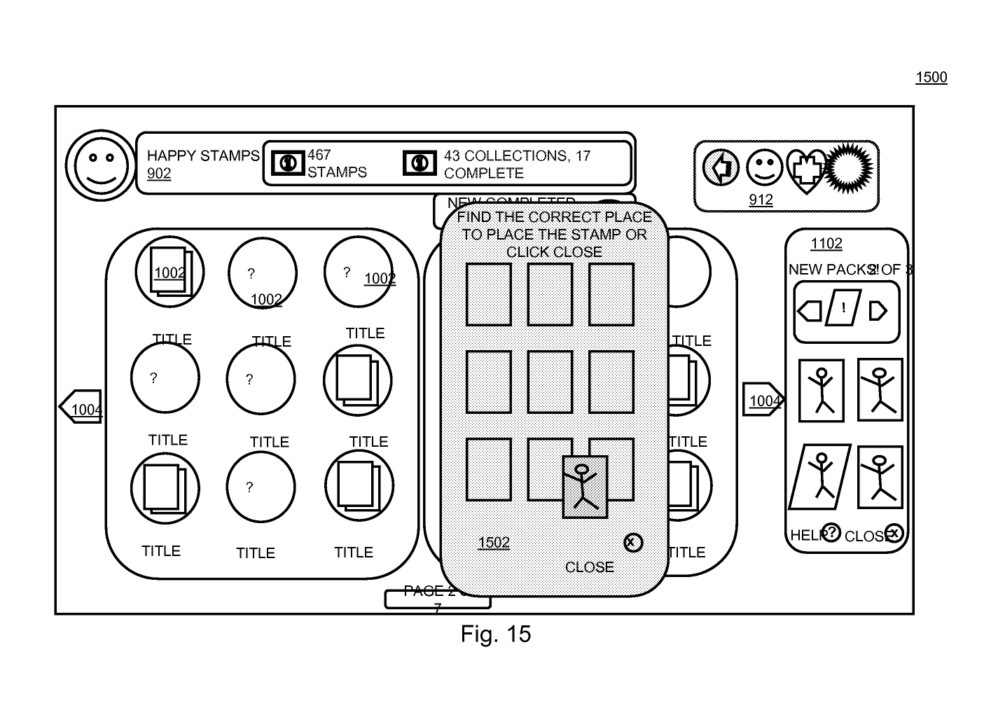

Referring to FIG. 11, when the New Stamps Menu may be selected from the Collections Page 1000, the New Packs dialog 1102 may appear. In an embodiment, the stamp book may shift to the left and the New Packs dialog 1102 may appear on the right. From the New Packs dialog 1102, individuals may first select a pack. Packs may be ordered by Level. A first pack may be opened when an individual may select a pack, as a default setting. When a pack may be opened, the thumbnails 1104 of each stamp within the pack may display in the main frame of the New Pack dialog. Selecting a stamp may bring up an overlay dialog 1202, such as in FIG. 12. An individual may place a stamp within its collection by dragging it over the correct collection's icon 1402 within the stamp book. Incorrect drops may be indicated by one of an audible alert, such as a buzz, a visual alert, such as a red highlight, a combination thereof, and the like, such as in FIG. 14. Correct drops may be indicated by one of an audible alert, such as a ding and a visual alert, such as a green highlight, a combination thereof, and the like, such as in FIG. 15. A correct drop may automatically open the collection's contact sheet 1502, such as in FIG. 15.

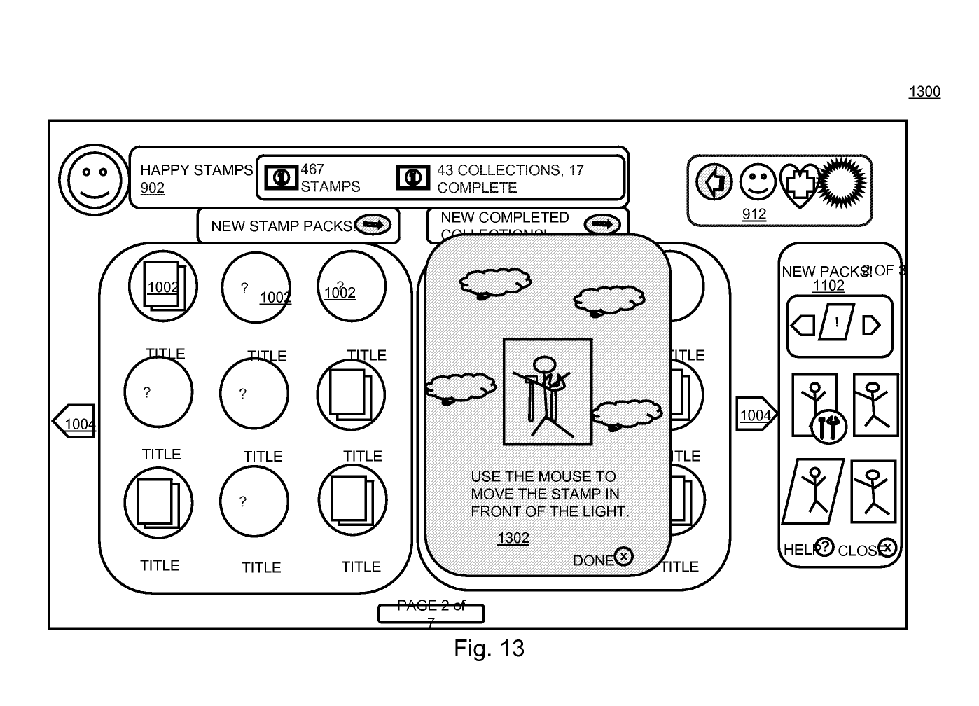

Referring to FIG. 12, selecting a stamp may display a contextual menu 1202 to allow the individual to “Pick Up” the stamp or to “Get Hint” or “Hold Up to Light” about the stamp. Picking up the stamp may allow the individual to place the stamp into a collection without having to hold down the mouse button to drag. A “Discover a Hint”, “Hold Up to Light”, or “Get Hint” button may display a screen 1302, such as in FIG. 13. Individuals may point the mouse up to move the stamp to the sun to reveal the collection's holographic icon which matches the picture of the collection within the stamp book. Stamps may have multiple hints that may be displayed based upon the amount of failed match attempts.

Referring to FIG. 15, once an individual correctly finds the collection, the collection contact sheet 1502 may appear. The name of each stamp may appear under each stamp slot. Owned, unlocked stamps may appear within their placements and unlocked stamps may appear as empty cells. The individual must match the picture of the stamp with the name of the stamp. To place a stamp, individuals may drag the stamp from the New Stamp dialog onto the appropriate place on the contact sheet.

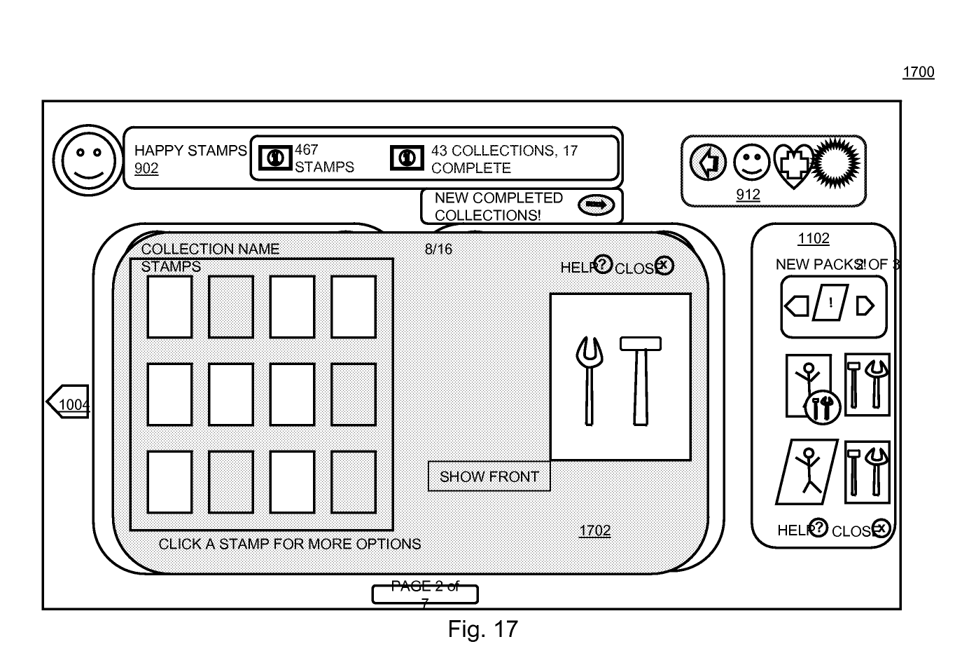

Referring to FIG. 16, selecting a stamp collection from the book may bring up the stamp collection sheet 1502. As an example of a default setting, the collection's unique image may display in the main frame. Once an individual may select an unlocked stamp from the collection, either a stamp's front 1602 or rear 1702 view may be displayed. For example, a view of the stamp, such as the front view 1602, may show the stamp's name, a large image, the stamp's rareness, the stamp's circulation, how many copies the individual may own of the stamp, and the like. Referring to FIG. 17, a view of the stamp, such as a back view 1702, may display the stamp's name, description, collection icon, and the like. When a user may select an unlocked stamp, a view of the stamp, such as the front view 1602, may display the name of the stamp, question mark image, rareness, circulation, and the like. The question mark image may indicate that the stamp is unlocked and that there may be additional material available with that stamp once it may be unlocked. Certain views, such as a back view, and certain information of the stamp may not be available to unlocked stamps.

While stamps have been used as an example of the invention's collectable, the invention is not limited by the foregoing examples and illustrations, but is to be understood in the broadest sense allowable by law. Collectables may include any item that an individual may want to collect, such as cards, pictures, figures, virtual items in association with a virtual play space, or the like, and may want to subsequently trade and accumulate in association with other individuals. In an embodiment, the collectable may be a real world object such as a baseball card, a doll, a stuffed animal, a historical item, coins, comic books, figurines, musical boxes, Olympic pins, political pins, scale models, musical instruments, and the like. In an embodiment, the collectable may entertainment, such as a video, DVD, movie, sporting event, musical event, and the like. In an embodiment, the collectable may be a virtual entity, such as a virtual character, an avatar, virtual furniture, virtual version of a real world object, and the like, and further, may be associated with a virtual play area that is part of the invention.

In an embodiment, the collecting, matching, and trading game may include a quiz system for individuals to earn points and bonus points to earn rewards. There may be a management interface for parents, graders, and system administrators to create online quizzes, where quizzes may be associated with completion of tasks, historical events in chart collection descriptions, clothing and costume descriptions, random trivia, and the like. Results from quizzes may be automatically graded, where managers assign points to completion of quizzes. Quizzes may be triggered off of events, such as calendar events, holiday events, task completion, level completion, collection completion, and the like. For instance, on St. Patrick's Day, a random trivia question associated with the holiday may be generated, such as where does a leprechaun keep his pot of gold? If the individual answers the question correctly, then they may be rewarded with bonus points. Quizzes may be based on an opinion poll, trivia, age based knowledge, and the like, and may be multiple choice, single choice, open ended, and the like. The quiz may also incorporate social aspects such as working on a quiz with a friend, see how your friend did on the quiz, publishing the quiz to multiple kids in different families, have kids create quizzes for each other using a list of questions that may have been provided by the manager or created by them.

In embodiments, the collecting, matching, and trading game may provide IM or chat to collaborate on doing chores, study, quizzes, community service, schoolwork, and the like. Integrating IM and chat may facilitate interaction in both the play and work parts of the individual's day. In embodiments, the individual may persistently see the user's scoreboard and an IM/chat panel that may stay with the individual throughout the invention's online environment. For instance, in an example, Jill logs in, sees that Mom has assigned her a new task to pick up her clothes and that Mrs. Donavan has posted an extra credit science project to research whales. In her chat window, Jill sees that in her 4th Grade Science Class buddy list, Susan is logged in. Jill pings Susan, “hey lets work on the science project together.” Jill and Susan point their cats to the Science Lab in the virtual world and bring up the assignment that is a web form of questions. They discuss the questions, fill them in together, and then submit their answers as a team. The test is graded immediately and they both receive 100 Bonus Points. Jill then sees that Jackie who is in her Neighborhood Friends buddy list is online: “Hey, I just earned some new points, let's play dress up!” Jill and Jackie load up Jill's cat and browse the catalog together picking different outfits to dress up Jill's cat. Jackie says: “Hey, I have a pair of heels that would look fab with that dress.” Jackie takes the heels from her own wardrobe and loans them to Jill. “Perfect, thanks Jackie!” In this example, the interaction may have been driven through the kids, but behind the scenes their parents may be the managers, ensuring that conditions, such as buddy lists and teacher contacts, are managed through the invention's facility.

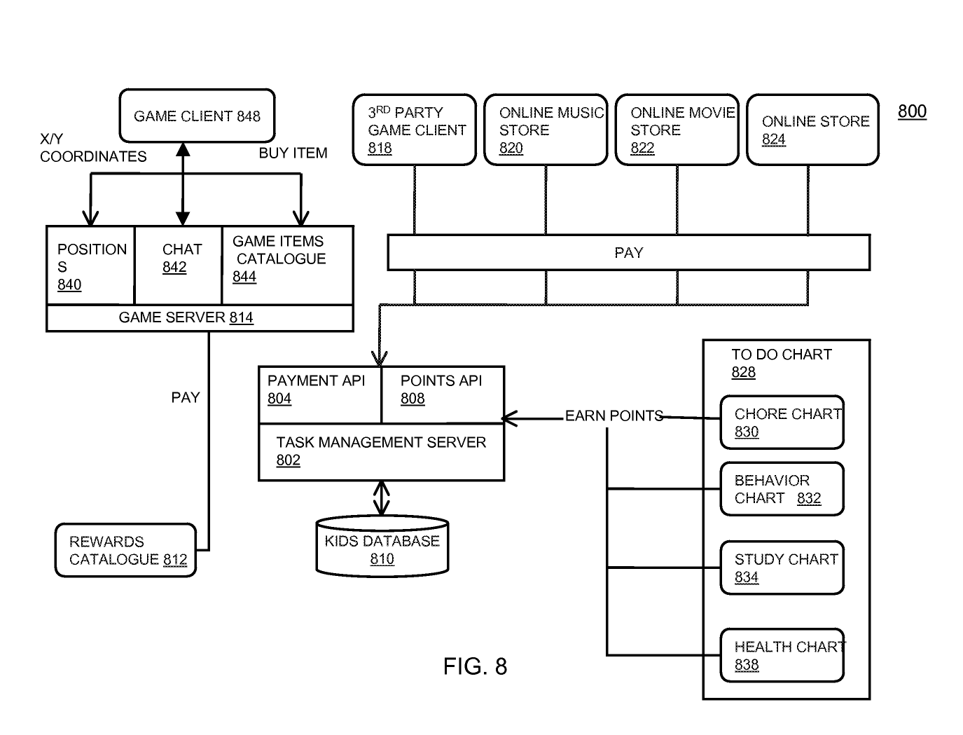

Referring to FIG. 8, an exemplary task management system 800 may be depicted. The Task Management Server 802 may host ‘To Do wizards’, ‘Rewards wizards’, ‘Internet Management facilities’, ‘Task Grading Facilities’, ‘Task History Facilities’, and the like. The Task Management Server 802 may be operably linked to a Kids Database 810. The Database 810 may store assigned tasks, progress on completion of tasks, points and game tokens balances, points deducted from a points balance, a goals list, and the like. The Task Management Server 802 may have a Payment Application Programming Interface (API) 804 and a Points API 808. The Points API 808 may be an interface with To Do Charts 828, such as a Chore Chart 830, a Behavior Chart 832, a Study Chart 834, a Health Chart 838, and the like. For example, a Behavior Chart 832 may be a collaborative management by a parent and a teacher. For example, a Health Chart 838 may be integrated with a heart rate monitor. The heart rate monitor may automatically update the Health Chart 838. For example, if a task is to get 30 minutes of exercise everyday, if the heart rate monitor detects an elevated heart rate, it may wirelessly indicate the elevation to the Health Chart 838. In an alternative embodiment, the individual may be required to synchronize a heart rate monitor with the Health Chart 838 facility in order to indicate that an exercise task has been completed. The Points API 808 may allow individuals to earn points from the indicated facilities. Points earned by an individual in the To Do Charts 828 may be received by the Points API 808 associated with the Task Management Server 802. Points may be stored, as described herein, in the Kids Database 810. The Payment API 804 may be a payment interface for a Rewards catalog 812, a Game Server 814, a third party game client 818, an online music store 820, an online movie store 822, an online store 824, and the like. The Payment API 804 may allow managers and individuals to use at the indicated facilities. When payment may be requested by the indicated facilities, the Payment API 804 associated with the Task Management Server 802 may request access to a points balance stored in the Kids Database 810. The Payment API 804 may implement any restrictions and/or approvals indicated by a manager. The Game Server 814 may host a Positions facility 840 for storing x/y coordinates received from and transmitting stored x/y coordinates to a Game Client 848. The Game Server 814 may host a Chat facility 842 for use within the Game Client 848. The Game Server 814 may host a Game Items Catalog 844 wherein individuals may purchase Game Items through the Game Client 848. A Game Token Exchange Calculator may pop-up or be otherwise activated when a Game Items Catalog 844 may be accessed. The Game Token Exchange Calculator may allow an individual to calculate how many points are needed to purchase a game item or how many points must be exchanged for sufficient game tokens to purchase a game item. Thus, the task management system 102 demonstrates an advantage of the invention in that the Task Management Server 802 facilitates the use of points earned in the To Do Chart 828 for payment of items and rewards within the Rewards Catalog 812, the Game Server 814, the Game Client 848, a third party game client 818, an online music store 820, an online movie store 822, an online store 824, and the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method of rewarding individuals for completing assigned tasks, comprising:
providing a collecting, matching, and trading game facility, wherein the facility provides collectables and collectable packs for collecting, matching, and trading as a reward for having reached a level of task completion; and
allowing the individual access to the collecting, matching, and trading game facility, wherein access is based on at least one of permission, a task completed, a number of tasks completed, and a value associated with task completion.

2. The method of claim 1, further comprising providing an additional reward for having reached a threshold level of task completion.

3-5. (canceled)

6. The method of claim 2, wherein the reward is dependent on an individual's grades.

7. The method of claim 2, wherein the reward is dependent on an individual's grade point average.

8-10. (canceled)

11. The method of claim 1, further comprising categorizing an assigned task by a category within a To Do chart.

12. The method of claim 11, further comprising providing a level meter associated with a To Do Chart for indicating a status of task completion.

13. The method of claim 12, wherein the collectable theme is associated with a level meter status.

14-31. (canceled)

32. The method of claim 1 further comprising, providing a quiz facility in association with the collecting, matching, and trading game facility.

33-39. (canceled)

40. The method of claim 32, wherein quizzes are associated with the completion of a task.

41-68. (canceled)

69. The method of claim 1, wherein points accumulated by tasks are summarized on a balance sheet.

70-83. (canceled)

84. The method of claim 1, wherein completing assigned tasks are associated with savings goals.

85-119. (canceled)

120. A method for managing tasks, comprising:
assigning at least one task to an individual;
associating the at least one task with a points value;
receiving an indication that the at least one task is completed;
grading the completed task; and
awarding points for a completed task to an individual.

121. The method of claim 120, wherein points are accumulated.

122. The method of claim 120, wherein points are exchanged for a reward.

123. The method of claim 122, wherein the reward is selected from a catalog, the selection of items available to an individual is determined by at least one of a game level, a points or game token balance, and the types and number of tasks completed.

124. The method of claim 123, wherein the catalog is dynamic.

125. The method of claim 123, wherein the catalog is static.

126. (canceled)

127. The method of claim 122, wherein the reward is at least one of Internet time, a real world item, a virtual item, a downloadable item, and a privilege.

128. The method of claim 127, further comprising providing a policy restricting access to the Internet during Internet time.

129. The method of claim 128, wherein the policy may be implemented by a browser plug-in.

130. The method of claim 120, wherein points are exchanged for game play.

131-138. (canceled)

139. The method of claim 120, further comprising deducting points for at least one of an incomplete task, late completion of a task, a poorly completed task, and poor behavior.

140-151. (canceled)

152. A method for managing Internet access, comprising:
selecting an individual for whom to create and/or edit an Internet access bookmark list;
selecting and approving Internet websites to include in an Internet access bookmark list;
optionally, customizing the name of the bookmark; and
configuring a browser plug-in to restrict Internet access by at least one of the Internet access bookmark list, a time, a points balance, a type of task completed, and a number of tasks completed.

153. The method of claim 152 wherein Internet access comprises access to at least one of a webpage, an online or downloadable movie, a streaming or downloadable video, an online or downloadable television show, a podcast, and online or downloadable music.
